(19) United States
(12) Patent Application Publication
(10) Pub. No.: US 2025/0111384 A1
(43) Pub. Date: Apr. 3, 2025

(54) DATA PROCESSING SYSTEMS FOR IDENTITY VALIDATION FOR CONSUMER RIGHTS REQUESTS AND RELATED METHODS

(71) Applicant: OneTrust, LLC, Atlanta, GA (US)

(72) Inventors: Jonathan Blake Brannon, Smyrna, GA (US); Steven W. Finch, Kennesaw, GA (US); Prashanth Sharma, Atlanta, GA (US); Jeremy Turk, Atlanta, GA (US); Priya Malhotra, Atlanta, GA (US); Kevin Jones, Atlanta, GA (US); Himanshu Arora, Atlanta, GA (US); Mahashankar Sarangapani, Atlanta, GA (US); Atul Gupta, Atlanta, GA (US)

(21) Appl. No.: 18/981,169

(22) Filed: Dec. 13, 2024

Related U.S. Application Data
(63) Continuation of application No. 17/710,653, filed on Mar. 31, 2022, now Pat. No. 12,190,330.
Application No. 17/710,653 is a continuation of application No. 17/383,889, filed on Jul. 23, 2021, now Pat. No. 11,295,316.
Application No. 17/383,889 is a continuation-in-part of application No. 17/149,380, filed on Jan. 14, 2021, now Pat. No. 11,074,367.
Application No. 17/149,380 is a continuation-in-part of application No. 16/410,336, filed on May 13, 2019, now Pat. No. 10,997,315.
Application No. 16/410,336 is a continuation-in-part of application No. 16/055,083, filed on Aug. 4, 2018, now Pat. No. 10,289,870.
Application No. 16/055,083 is a continuation-in-part of application No. 15/996,208, filed on Jun. 1, 2018, now Pat. No. 10,181,051.
Application No. 15/996,208 is a continuation-in-part of application No. 15/853,674, filed on Dec. 22, 2017, now Pat. No. 10,019,597.
Application No. 15/853,674 is a continuation-in-part of application No. 15/619,455, filed on Jun. 10, 2017, now Pat. No. 9,851,966.
Application No. 15/619,455 is a continuation-in-part of application No. 15/254,901, filed on Sep. 1, 2016, now Pat. No. 9,729,583.
(60) Provisional application No. 62/961,054, filed on Jan. 14, 2020.
(60) Provisional application No. 62/360,123, filed on Jul. 8, 2016.
(60) Provisional application No. 62/353,802, filed on Jun. 23, 2016.
(60) Provisional application No. 62/348,695, filed on Jun. 10, 2016.
(60) Provisional application No. 62/541,613, filed on Aug. 4, 2017.
(60) Provisional application No. 62/537,839, filed on Jul. 27, 2017.
(60) Provisional application No. 62/547,530, filed on Aug. 18, 2017.

(51) Int. Cl. G06Q 30/018; G06Q 50/18; H04L 9/40

(52) U.S. Cl. CPC G06Q 30/018; G06Q 50/184; H04L 63/107

(57) ABSTRACT

Embodiments of the present invention provide methods, apparatus, systems, computing devices, computing entities, and/or the like for verifying the identity of a data subject. In one embodiment, a method is provided comprising: receiving, via a browser, a consumer rights request for a data subject for performing an action with regard to personal data associated with the data subject; detecting a state of the browser indicating a location; identifying a law based on the location; determining a level of identity verification required based on the law; generating, based on the level, a GUI by configuring a first prompt on the GUI configured for receiving input for a first type of identity verification; transmitting an instruction to present the GUI; receiving the input for the first type of identity verification; verifying the identity of the data subject based on the input; and responsive to verifying the identity, causing performance of the action.

### CROSS REFERENCE TO RELATED APPLICATIONS

This application is a continuation of U.S. patent application Ser. No. 17/710,653, filed Mar. 31, 2022, which is a continuation of U.S. patent application Ser. No. 17/383,889, filed Jul. 23, 2021, now U.S. Pat. No. 11,295,316, issued Apr. 5, 2022, which is a continuation-in-part of U.S. patent application Ser. No. 17/149,380, filed Jan. 14, 2021, now U.S. Pat. No. 11,074,367, issued Jul. 27, 2021, which claims priority from U.S. Provisional Patent Application Ser. No. 62/961,054, filed Jan. 14, 2020, and is also a continuation-in-part of U.S. patent application Ser. No. 16/410,336, filed May 13, 2019, now U.S. Pat. No. 10,997,315, issued May 4, 2021, which is a continuation-in-part of U.S. patent application Ser. No. 16/055,083, filed Aug. 4, 2018, now U.S. Pat. No. 10,289,870, issued May 14, 2019, which claims priority from U.S. Provisional Patent Application Ser. No. 62/547,530, filed Aug. 18, 2017, and is also a continuation-in-part of U.S. patent application Ser. No. 15/996,208, filed Jun. 1, 2018, now U.S. Pat. No. 10,181,051, issued Jan. 15, 2019, which claims priority from U.S. Provisional Patent Application Ser. No. 62/537,839 filed Jul. 27, 2017, and is also a continuation-in-part of U.S. patent application Ser. No. 15/853,674, filed Dec. 22, 2017, now U.S. Pat. No. 10,019,597, issued Jul. 10, 2018, which claims priority from U.S. Provisional Patent Application Ser. No. 62/541,613, filed Aug. 4, 2017, and is also a continuation-in-part of U.S. patent application Ser. No. 15/619,455, filed Jun. 10, 2017, now U.S. Pat. No. 9,851,966, issued Dec. 26, 2017, which is a continuation-in-part of U.S. patent application Ser. No. 15/254,901, filed Sep. 1, 2016, now U.S. Pat. No. 9,729,583, issued Aug. 8, 2017, which claims priority from: (1) U.S. Provisional Patent Application Ser. No. 62/360,123, filed Jul. 8, 2016; (2) U.S. Provisional Patent Application Ser. No. 62/353,802, filed Jun. 23, 2016; and (3) U.S. Provisional Patent Application Ser. No. 62/348,695, filed Jun. 10, 2016. The disclosures of all of the above patent applications are hereby incorporated herein by reference in their entirety.

### BACKGROUND

Over the past years, privacy and security policies, and related operations have become increasingly important. Breaches in security, leading to the unauthorized access of personal data (which may include sensitive personal data) have become more frequent among companies and other organizations of all sizes. Such personal data may include, but is not limited to, personally identifiable information (PII), which may be information that directly (or indirectly) identifies an individual or entity. Examples of PII include names, addresses, dates of birth, social security numbers, and biometric identifiers such as a person's fingerprints or picture. Other personal data may include, for example, customers' Internet browsing habits, purchase history, and even their preferences (e.g., likes and dislikes, as provided or obtained through social media).

Many organizations that obtain, use, and transfer personal data, including sensitive personal data, have begun to address these privacy and security issues. To manage personal data, many organizations have attempted to implement operational policies and processes that comply with legal and industry requirements, as well as comply with certain rights related to a data subject's personal data that is collected, stored, or otherwise processed by an organization. These rights may include, for example, a right to obtain confirmation of whether a particular organization is processing their personal data, a right to obtain information about the purpose of the processing (e.g., one or more reasons for which the personal data was collected), and other such rights. Some regulations require organizations to comply with requests for such information (e.g., Data Subject Access Requests) within relatively short periods of time (e.g., 30 days).

Existing systems for complying with such requests can be inadequate for producing and providing the required information within the required timelines. In addition, existing systems for complying with such requests can be inadequate for producing and providing the required information while doing so in a secure manner that ensures the information is not improperly accessed. This is especially the case for large corporations, which may store data on several different platforms in differing locations. Accordingly, there is a need for improved systems and methods for complying with data subject access requests. In addition, there is a need for improved systems and methods for complying with data subject access requests that do so in a secure manner to ensure personal data is not improperly accessed.

### SUMMARY

In accordance with various aspects, a method is provided. Accordingly, the method comprises: receiving, by computing hardware, a request originating from a computing device, wherein the request is for a particular entity to perform an action with regard to data associated with a data subject; detecting, by the computing hardware, a state of a browser application executing on the computing device indicating a location of the computing device; determining, by the computing hardware and based on the location, a first type of identity verification and a second type of identity verification; determining, by the computing hardware, that the first type of identity verification requires first user-provided input to verify an identity of the data subject that is less than second user-provided input required by the second type of identity verification to verify the identity of the data subject; transmitting, by the computing hardware, an instruction to the computing device to dynamically display a prompt for the first user-provided input; receiving, by the computing hardware, the first user-provided input via the prompt; verifying, by the computing hardware, the identity of the data subject based on the first user-provided input; and responsive to verifying the identity of the data subject, causing, by the computing hardware, performance of the action with regard to the data associated with the data subject.

In particular aspects, the action comprises at least one of retrieving and displaying the data on the computing device, deleting the data from at least one data repository, or updating the data in the at least one data repository. In particular aspects, the location of the computing device comprises at least one of a current geographical location of the computing device or a past geographical location of the computing device. In particular aspects, verifying the identity of the data subject based on the first user-provided input comprises: providing first information included in the request to an external system; receiving second information from the external system based on the first information; and verifying the identity of the data subject based on the first user-provided input and the second information.

In particular aspects, the method further comprises generating, by the computing hardware, a knowledge-based authentication question based on the second information, wherein the prompt comprises the knowledge-based authentication question and the first user-provided input comprises an answer to the knowledge-based authentication question. In particular aspects, the prompt comprises a secure link through which the first user-provided input is provided to prevent outside access to the first user-provided input. In particular aspects, dynamically displaying the prompt for the first user-provided input comprises providing a custom user interface for the data subject based on the location.

In accordance with various aspects, a system is provided comprising a non-transitory computer-readable medium storing instructions and a processing device communicatively coupled to the non-transitory computer-readable medium. In particular aspects, the processing device is configured to execute the instructions and thereby perform operations comprising: receiving a request originating from a computing device, wherein the request involves performing an action with regard to data associated with a data subject; detecting a state of a browser application executing on the computing device indicating a location of the computing device; determining, based on the location, a first type of identity verification and a second type of identity verification; determining that the first type of identity verification requires first user-provided input to verify an identity of the data subject that is less than second user-provided input required by the second type of identity verification to verify the identity of the data subject; causing a prompt to display, wherein the prompt requests the first user-provided input; receiving the first user-provided input; verifying the identity of the data subject based on the first user-provided input; and responsive to verifying the identity of the data subject, causing performance of the action with regard to the data associated with the data subject.

In particular aspects, the action comprises at least one of retrieving and displaying the data on the computing device, deleting the data from at least one data repository, or updating the data in the at least one data repository. In particular aspects, the location of the computing device comprises at least one of a current geographical location of the computing device or a past geographical location of the computing device. In particular aspects, verifying the identity of the data subject based on the first user-provided input comprises: providing first information included in the request to an external system; receiving second information from the external system based on the first information; and verifying the identity of the data subject based on the first user-provided input and the second information.

In particular aspects, the operations further comprising generating a knowledge-based authentication question based on the second information, and the prompt comprises the knowledge-based authentication question and the first user-provided input comprises an answer to the knowledge-based authentication question. In particular aspects, the prompt comprises a secure link through which the first user-provided input is provided to prevent outside access to the first user-provided input. In particular aspects, causing the prompt to display requesting the first user-provided input comprises providing a custom user interface for the data subject based on the location.

In accordance with various aspects, a non-transitory computer-readable medium having program code that is stored thereon. In particular aspects, the program code executable by one or more processing devices performs operations comprising: receiving a request originating from a computing device to perform an action with regard to data associated with a data subject; detecting a state of a browser application executing on the computing device indicating a location of the computing device; determining, based on the location, a first type of identity verification and a second type of identity verification; determining that the first type of identity verification requires first user-provided input to verify an identity of the data subject that is less than second user-provided input required by the second type of identity verification to verify the identity of the data subject; causing a prompt to display via the browser application, wherein the prompt requests the first user-provided input; receiving the first user-provided input originating from the computing device; verifying the identity of the data subject based on the first user-provided input; and responsive to verifying the identity of the data subject, causing performance of the action with regard to the data associated with the data subject.

In particular aspects, the action comprises at least one of retrieving and displaying the data on the computing device, deleting the data from at least one data repository, or updating the data in the at least one data repository. In particular aspects, the location of the computing device comprises at least one of a current geographical location of the computing device or a past geographical location of the computing device. In particular aspects, verifying the identity of the data subject based on the first user-provided input comprises: providing first information included in the request to an external system; receiving second information from the external system based on the first information; and verifying the identity of the data subject based on the first user-provided input and the second information.

In particular aspects, the operations further comprise generating a knowledge-based authentication question based on the second information, the prompt comprises the knowledge-based authentication question and the first user-provided input comprises an answer to the knowledge-based authentication question. In particular aspects, the prompt comprises a secure link through which the first user-provided input is provided to prevent outside access to the first user-provided input.

### BRIEF DESCRIPTION OF THE DRAWINGS

Various embodiments of a data subject access request fulfillment system are described below. In the course of this description, reference will be made to the accompanying drawings, which are not necessarily drawn to scale, and wherein:

FIG. 1 depicts a data subject request processing and fulfillment system according to particular embodiments.

FIG. 2A is a schematic diagram of a computer (such as the data model generation server 110, or data model population server 120 of FIG. 1) that is suitable for use in various embodiments of the data subject request processing and fulfillment system shown in FIG. 1.

FIG. 2B is a flow chart depicting exemplary steps executed by a Data Subject Access Request Routing Module according to a particular embodiment

FIGS. 3-43 are computer screen shots that demonstrate the operation of various embodiments.

FIGS. 44-49 depict various exemplary screen displays and user interfaces that a user of various embodiments of the system may encounter (FIGS. 47 and 48 collectively show four different views of a Data Subject Request Queue).

FIG. 50 is a flowchart showing an example of a processes performed by a Data Subject Identity Validation Module according to various embodiments

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

Ticket management systems, according to various embodiments, are adapted to receive data subject access requests (DSAR's) from particular data subjects, and to facilitate the timely processing of valid DSAR's by an appropriate respondent. In particular embodiments, the ticket management system receives DSAR's via one or more webforms that each may, for example, respectively be accessed via an appropriate link/button on a respective web page. In other embodiments, the system may receive DSAR's through any other suitable mechanism, such as via a computer software application (e.g., a messaging application such as Slack, Twitter), via a chat bot, via generic API input from another system, or through entry by a representative who may receive the information, for example, via suitable paper forms or over the phone.

The ticket management system may include a webform creation tool that is adapted to allow a user to create customized webforms for receiving DSAR's from various different data subject types and for routing the requests to appropriate individuals for processing. The webform creation tool may, for example, allow the user to specify the language that the form will be displayed in, what particular information is to be requested from the data subject and/or provided by the data subject, who any DSAR's that are received via the webform will be routed to, etc. In particular embodiments, after the user completes their design of the webform, the webform creation tool generates code for the webform that may be cut and then pasted into a particular web page.

The system may be further adapted to facilitate processing of DSAR's that are received via the webforms, or any other suitable mechanism. For example, the ticket management system may be adapted to execute one or more of the following steps for each particular DSAR received via the webforms (or other suitable mechanism) described above: (1) before processing the DSAR, confirm that the DSAR was actually submitted by the particular data subject of the DSAR (or, for example, by an individual authorized to make the DSAR on the data subject's behalf, such as a parent, guardian, power-of-attorney holder, etc.)—any suitable method may be used to confirm the identity of the entity/individual submitting the DSAR—for example, if the system receives the DSAR via a third-party computer system, the system may validate authentication via API secret, or by requiring a copy of one or more particular legal documents (e.g., a particular contract between two particular entities)—the system may validate the identity of an individual by, for example, requiring the individual (e.g., data subject) to provide particular account credentials, by requiring the individual to provide particular out-of-wallet information, through biometric scanning of the individual (e.g., finger or retinal scan), or via any other suitable identity verification technique; (2) if the DSAR was not submitted by the particular data subject, deny the request; (3) if the DSAR was submitted by the particular data subject, advance the processing of the DSAR; (4) route the DSAR to the correct individual(s) or groups internally for handling; (5) facilitate the assignment of the DSAR to one or more other individuals for handling of one or more portions of the DSAR; (6) facilitate the suspension of processing of the data subject's data by the organization; and/or (7) change the policy according to which the data subject's personal data is retained and/or processed by the system. In particular embodiments, the system may perform any one or more of the above steps automatically. The system then generates a receipt for the DSAR request that the user can use as a transactional record of their submitted request.

In particular embodiments, the ticket management system may be adapted to generate a graphical user interface (e.g., a DSAR request-processing dashboard) that is adapted to allow a user (e.g., a privacy officer of an organization that is receiving the DSAR) to monitor the progress of any of the DSAR requests. The GUI interface may display, for each DSAR, for example, an indication of how much time is left (e.g., quantified in days and/or hours) before a legal and/or internal deadline to fulfill the request. The system may also display, for each DSAR, a respective user-selectable indicium that, when selected, may facilitate one or more of the following: (1) verification of the request; (2) assignment of the request to another individual; (3) requesting an extension to fulfill the request; (4) rejection of the request; or (5) suspension of the request.

As noted immediately above, and elsewhere in this application, in particular embodiments, any one or more of the above steps may be executed by the system automatically. As a particular example, the system may be adapted to automatically verify the identity of the DSAR requestor and then automatically fulfill the DSAR request by, for example, obtaining the requested information via a suitable data model and communicating the information to the requestor. As another particular example, the system may be configured to automatically route the DSAR to the correct individual for handling based at least in part on one or more pieces of information provided (e.g., in the webform).

In various embodiments, the system may be adapted to prioritize the processing of DSAR's based on metadata about the data subject of the DSAR. For example, the system may be adapted for: (1) in response to receiving a DSAR, obtaining metadata regarding the data subject; (2) using the metadata to determine whether a priority of the DSAR should be adjusted based on the obtained metadata; and (3) in response to determining that the priority of the DSAR should be adjusted based on the obtained metadata, adjusting the priority of the DSAR.

Examples of metadata that may be used to determine whether to adjust the priority of a particular DSAR include: (1) the type of request; (2) the location from which the request is being made; (3) the country of residency of the data subject and, for example, that county's tolerance for enforcing DSAR violations; (4) current sensitivities to world events; (5) a status of the requestor (e.g., especially loyal customer); or (6) any other suitable metadata.

### Technical Contributions of Various Embodiments

As previously noted, privacy and security policies, and related operations, have become increasingly important over the past years. As a result, many organizations that obtain, use, and transfer personal data, including sensitive personal data, have begun to address many privacy and security issues involving these privacy and security policies. For instance, to manage personal data, many organizations have attempted to implement operational policies and processes that comply with legal and industry requirements, as well as comply with certain rights related to a data subject's personal data that is collected, stored, or otherwise processed by an organization. These rights may include, for example, a right to obtain confirmation of whether a particular organization is processing their personal data, a right to obtain information about the purpose of the processing (e.g., one or more reasons for which the personal data was collected), and other such rights. Some regulations require organizations to comply with requests for such information (e.g., Data Subject Access Requests) within relatively short periods of time (e.g., 30 days).

However, a technical challenge often encountered by many organizations in their use of personal data while complying with a data subject's rights related to his or her personal data that is collected, stored, or otherwise processed by the organization is facilitating (e.g., allowing) the data subject's exercise of such rights while ensuring the data subject's personal data is not accessed (e.g., breached) by an unauthorized third party. For example, a technical challenge often encountered by many organizations is receiving requests from imposters who pose as data subjects to gain access to the data subjects' personal data. To combat these imposters, organizations will put identity verification processes in place to verify a requestor's identity as the corresponding data subject prior to processing a request associated with the data subject's personal data.

However, such verification does not have a one-size-fits-all solution with respect to receiving requests to process data subjects' personal data. For instance, different levels and/or types of identity verification may be required for different rights (e.g., for different processing of personal data) and/or regulations/laws. For example, a first type of identity verification may be required for a request received for obtaining information on why an organization is processing a data subject's personal data and a second, different type of identity verification may be required for a request received for deleting a data subject's personal data. In addition, the level and/or type of identity verification that is required may be based on the applicable regulations and/or laws. Further, external factors associated with the requests may warrant different levels and/or types of identity verification. This may be true even when two requests are received for the same type of processing of personal data for data subjects.

For example, two requests may be received that involve returning the personal data for two different data subjects that has been collected by a particular organization. Here, the first request may have originated from a location that corresponds to the related data subject's country of residency. While the second request may have originated from a location that does not correspond to the related data subject's country of residency. Therefore, in this instance, a higher level and/or more thorough type of identity verification of the requester may be required for the second request than for the first request since the source of the second request is from a foreign country, which may indicate the second request is more likely to have been submitted by an imposter. Therefore, a technical challenge encountered by many organizations is dynamically adjusting (which can oftentimes be on the fly) for the different levels and/or types of identity verification that may be required for different requests received for personal data.

Accordingly, various embodiments of present disclosure overcome many of the technical challenges associated with dynamically adjusting the identity verification process for different personal data requests to comply with verification requirements found in applicable standards, regulations, laws, and/or the like, as well as account for applicable external factors, by facilitating the generating and/or configuring of a graphical user interface that presents the appropriate identity verification process and/or requirements that may be applicable to a particular request from among multiple potentially applicable identity verification processes and/or requirements. Specifically, various embodiments of the disclosure are directed to a computational framework configured for using data detected at a user device, such as browser state data, to determine the appropriate level of identity verification required to present to the user in a graphical user interface in order to display one or more input elements such as applicable identity verification prompts to acquire identity information from the user (e.g., from the requestor of a personal data request). User device data (e.g., state data) may include or indicate one or more parameters that may be used to determine a level of identity verification required for a particular personal data request. The system may then identify one or more input elements (e.g., identity verification prompts) that correspond to the determined level of identity verification required to configure on a graphical user interface. The system may also, or instead, identify one or more input elements (e.g., identity verification prompts) that do not correspond to the determined level of identity verification required and may, in response, determine to exclude those one or more input elements (e.g., identity verification prompts) from the graphical user interface presented to the user. Accordingly, the input elements (e.g., identity verification prompts) included in the graphical user interface allow for the user (e.g., requestor) to provide required identity information via the user device that can then be used in verifying the identity of the user. Depending on the embodiment, the system may determine and/or use, from user device data, one or more (e.g., any combination) of various user parameters, factors, criteria, entity parameters, factors, criteria, website/webpage parameters, factors, criteria, associated product and/or service parameters, factors, criteria, etc. to determine the applicable level of identity verification required for a personal data request and generate and/or configure a graphical user interface with the appropriate input elements (e.g., identity verification prompts) accordingly.

Accordingly, various embodiments of the disclosure provided herein enable more effective, efficient, reliable, and accurate identity verification required in processing personal data requests received from a variety of requestors. In addition, various embodiments provided herein facilitate the dynamic generation and/or configuration of a graphical user interface with the appropriate input elements (e.g., identity verification prompts) to comply with a level of identity verification required for a variety of different personal data requests that may be received. By doing so, the various embodiments help ensure that proper identity verification of requestors is carried out for received personal data requests and that improper (e.g., unlawful and/or unconsented) access to personal data is not obtained by unauthorized third parties. In facilitating the identification of the applicable input elements (e.g., identity verification prompts) required for different types of personal data requests, various embodiments of the present disclosure make major technical contributions to improving the computational efficiency and reliability of various privacy management systems and procedures used in processing personal data requests that can ensure compliance with legal and industry requirements, as well as ensure compliance with certain rights related to a data subject's personal data that is collected, stored, or otherwise processed by an organization. This in turn translates to more computationally efficient software systems. Further detail is now provided for different aspects of various embodiments of the disclosure.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general-purpose computer, special-purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

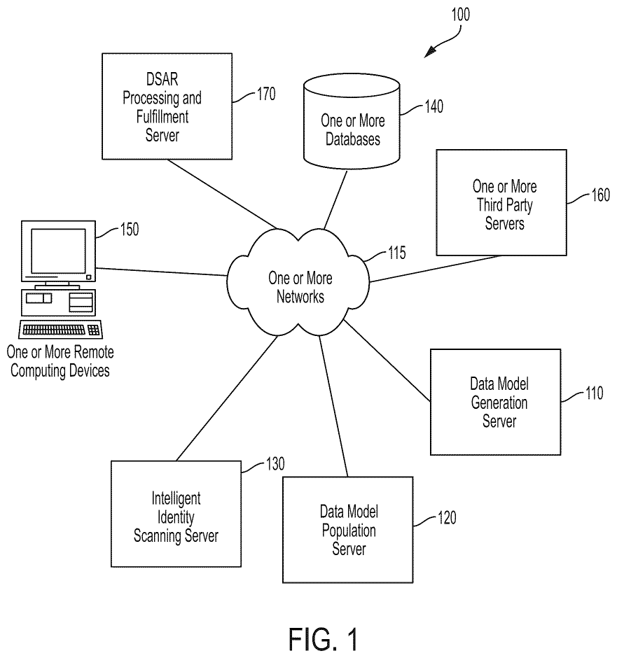

FIG. 1 is a block diagram of a data subject access request fulfillment system 100 according to a particular embodiment. In various embodiments, the data subject access request fulfillment system 100 is part of a privacy compliance system (also referred to as a privacy management system), or other system, which may, for example, be associated with a particular organization and be configured to aid in compliance with one or more legal or industry regulations related to the collection and storage of personal data.

As may be understood from FIG. 1, the data subject access request fulfillment system 100 includes one or more computer networks 115, a Data Model Generation Server 110, a Data Model Population Server 120, an Intelligent Identity Scanning Server 130 (which may automatically validate a DSAR requestor's identity), One or More Databases 140 or other data structures, one or more remote computing devices 150 (e.g., a desktop computer, laptop computer, tablet computer, smartphone, etc.), and One or More Third Party Servers 160. In particular embodiments, the one or more computer networks 115 facilitate communication between the Data Model Generation Server 110, Data Model Population Server 120, Intelligent Identity Scanning Server 130, One or More Databases 140, one or more remote computing devices 150 (e.g., a desktop computer, laptop computer, tablet computer, smartphone, etc.), One or More Third Party Servers 160, and DSAR Processing and Fulfillment Server 170. Although in the embodiment shown in FIG. 1, the Data Model Generation Server 110, Data Model Population Server 120, Intelligent Identity Scanning Server 130, One or More Databases 140, one or more remote computing devices 150 (e.g., a desktop computer, laptop computer, tablet computer, smartphone, etc.), and One or More Third Party Servers 160, and DSAR Processing and Fulfillment Server 170 are shown as separate servers, it should be understood that in other embodiments, the functionality of one or more of these servers and/or computing devices may, in different embodiments, be executed by a larger or smaller number of local servers, one or more cloud-based servers, or any other suitable configuration of computers.

The one or more computer networks 115 may include any of a variety of types of wired or wireless computer networks such as the Internet, a private intranet, a public switch telephone network (PSTN), or any other type of network. The communication link between the DSAR Processing and Fulfillment Server 170 and the One or More Remote Computing Devices 150 may be, for example, implemented via a Local Area Network (LAN) or via the Internet. In other embodiments, the One or More Databases 140 may be stored either fully or partially on any suitable server or combination of servers described herein.

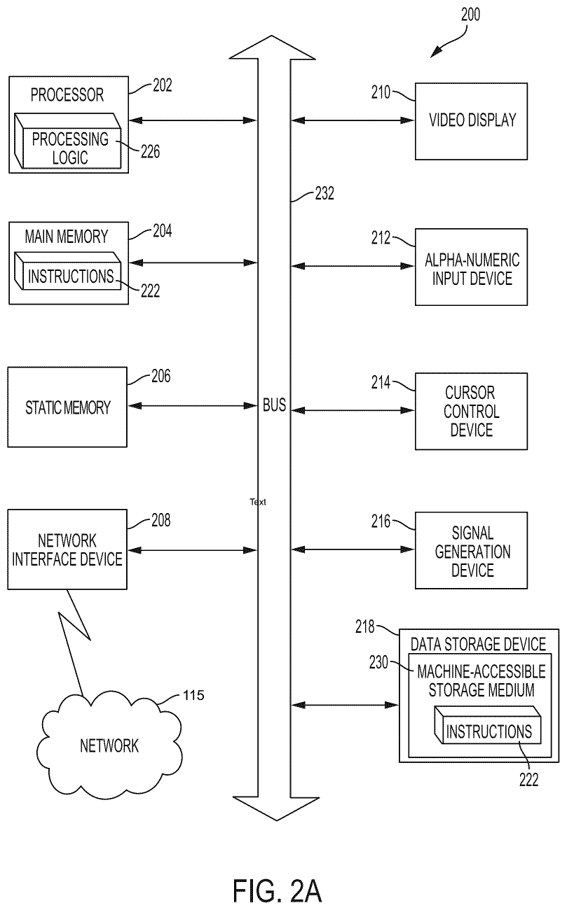

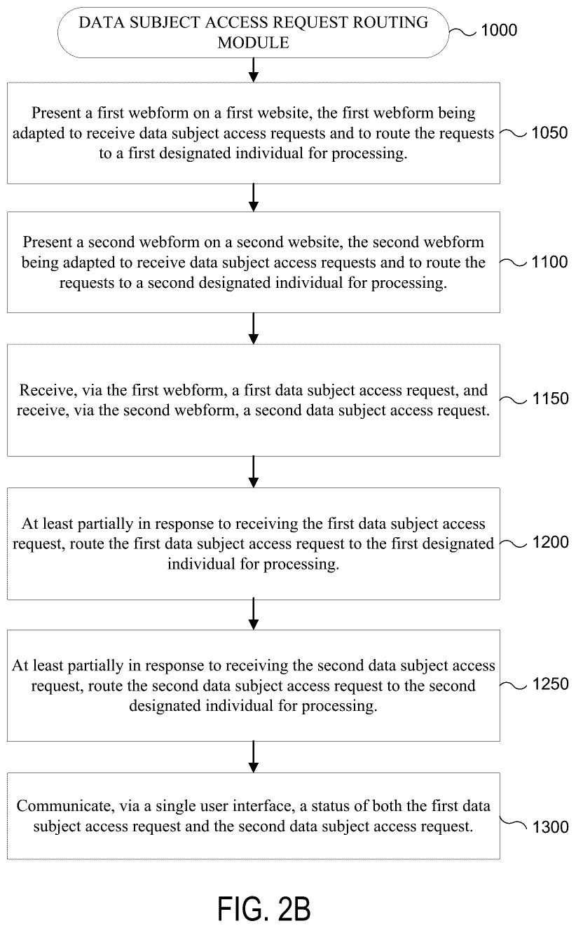

FIG. 2A illustrates a diagrammatic representation of a computer 200 that can be used within the data subject access request fulfillment system 100, for example, as a client computer (e.g., one or more remote computing devices 150 shown in FIG. 1), or as a server computer (e.g., Data Model Generation Server 110 shown in FIG. 1). In particular embodiments, the computer 200 may be suitable for use as a computer within the context of the data subject access request fulfillment system 100 that is configured for routing and/or processing DSAR requests and/or generating one or more data models used in automatically fulfilling those requests.

In particular embodiments, the computer 200 may be connected (e.g., networked) to other computers in a LAN, an intranet, an extranet, and/or the Internet. As noted above, the computer 200 may operate in the capacity of a server or a client computer in a client-server network environment, or as a peer computer in a peer-to-peer (or distributed) network environment. The Computer 200 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 200 may further include a network interface device 208. The computer 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software instructions 222) embodying any one or more of the methodologies or functions described herein. The software instructions 222 may also reside, completely or at least partially, within main memory 204 and/or within processing device 202 during execution thereof by computer 200—main memory 204 and processing device 202 also constituting computer-accessible storage media. The software instructions 222 may further be transmitted or received over a network 115 via network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The terms “computer-accessible storage medium”, “computer-readable medium”, and like terms should also be understood to include any medium that is capable of storing, encoding or carrying a set of instructions for execution by the computer and that cause the computer to perform any one or more of the methodologies of the present invention. These terms should accordingly be understood to include, but not be limited to, solid-state memories, optical and magnetic media, etc.

### Systems for Managing Data Subject Access Requests

In various embodiments, the system may include a ticket management system and/or other systems for managing data subject access requests. In operation, the system may use one or more computer processors, which are operatively coupled to memory, to execute one or more software modules (which may be included in the Instructions 222 referenced above) such as: (1) a Data Subject Access Request Routing Module 1000; and (4) a DSAR Prioritization Module. An overview of the functionality and operation of each of these modules is provided below.

### Data Subject Access Request Routing Module 1000

As shown in FIG. 2B, a Data Subject Access Request Routing Module 1000, according to particular embodiments, is adapted for executing the steps of: (1) at Step 1050, presenting, by at least one computer processor, a first webform on a first website, the first webform being adapted to receive data subject access requests and to route the requests to a first designated individual (e.g., an individual who is associated with a first sub-organization of a particular organization—e.g., an employee of the first sub-organization) for processing (in various embodiments, “presenting a webform on a website” may comprise, for example: (A) providing a button, link, or other selectable indicium on the website that, when selected, causes the system to display the webform, or (B) displaying the webform directly on the website); (2) at Step 1100 presenting, by at least one computer processor, a second webform on a second website, the second webform being adapted to receive data subject access requests and to route the requests to a second designated individual (e.g., an individual who is associated with a second sub-organization of a particular organization—e.g., an employee of the second sub-organization) for processing; (3) at Step 1150, receiving, by at least one computer processor, via the first webform, a first data subject access request; (4) at Step 1200, at least partially in response to the receiving the first data subject access request, automatically routing the first data subject access request to the first designated individual for handling; (5) at Step 1250, at least partially in response to the receiving the second data subject access request, automatically routing the second data subject access request to the second designated individual for handling; and (6) at Step 1300, communicating, via a single user interface, a status of both the first data subject access request and the second data subject access request.

In particular embodiments: (1) the first website is a website of a first sub-organization of a particular parent organization; (2) the second website is a website of a second sub-organization of the particular parent organization; and (3) the computer-implemented method further comprises communicating, by at least one computer processor, via a single user interface, a status of each of said first data subject access request and said second data subject access request (e.g., to an employee of—e.g., privacy officer of—the parent organization). As discussed in more detail below, this single user interface may display an indication, for each respective one of the first and second data subject access requests, of a number of days remaining until a deadline for fulfilling the respective data subject access request.

In certain embodiments, the single user interface is adapted to facilitate the deletion or assignment of multiple data subject access requests to a particular individual for handling in response to a single command from a user (e.g., in response to a user first selecting multiple data subject access requests from the single user interface and then executing an assign command to assign each of the multiple requests to a particular individual for handling).

In particular embodiments, the system running the Data Subject Access Request Routing Module 1000, according to particular embodiments, may be adapted for, in response to receiving each data subject access request, generating an ID number (e.g., a transaction ID or suitable Authentication Token) for the first data subject access request, which may be used later, by the DSAR requestor, to access information related to the DSAR, such as personal information requested via the DSAR, the status of the DSAR request, etc. To facilitate this, the system may be adapted for receiving the ID number from an individual and, at least partially in response to receiving the ID number from the individual, providing the individual with information regarding status of the data subject access request and/or information previously requested via the data subject access request.

In particular embodiments, the system may be adapted to facilitate the processing of multiple different types of data subject access requests. For example, the system may be adapted to facilitate processing: (1) requests for all personal data that an organization is processing for the data subject (a copy of the personal data in a commonly used, machine-readable format); (2) requests for all such personal data to be deleted; (3) requests to update personal data that the organization is storing for the data subject; (4) requests to opt out of having the organization use the individual's personal information in one or more particular ways (e.g., per the organization's standard business practices), or otherwise change the way that the organization uses the individual's personal information; and/or (5) the filing of complaints.

In particular embodiments, the system may execute one or more steps (e.g., any suitable step or steps discussed herein) automatically. For example, the system may be adapted for: (1) receiving, from the first designated individual, a request to extend a deadline for satisfying the first data subject access request; (2) at least partially in response to receiving the extension request, automatically determining, by at least one processor, whether the requested extension complies with one or more applicable laws or internal policies; and (3) at least partially in response to determining that the requested extension complies with the one or more applicable laws or internal policies, automatically modifying the deadline, in memory, to extend the deadline according to the extension request. The system may be further adapted for, at least partially in response to determining that the requested extension does not comply with the one or more applicable laws or internal policies, automatically rejecting the extension request. In various embodiments, the system may also, or alternatively, be adapted for: (1) at least partially in response to determining that the requested extension does not comply with the one or more applicable laws or internal policies, automatically modifying the length of the requested extension to comply with the one or more applicable laws or internal policies; and (2) automatically modifying the deadline, in memory, to extend the deadline according to the extension request.

In various embodiments, the system may be adapted for: (1) automatically verifying an identity of a particular data subject access requestor placing the first data subject access request; (2) at least partially in response to verifying the identity of the particular data subject access requestor, automatically obtaining, from a particular data model, at least a portion of information requested in the first data subject access request; and (3) after obtaining the at least a portion of the requested information, displaying the obtained information to a user as part of a fulfillment of the first data subject access request. The information requested in the first data subject access request may, for example, comprise at least substantially all (e.g., most or all) of the information regarding the first data subject that is stored within the data model.

In various embodiments, the system is adapted for: (1) automatically verifying, by at least one computer processor, an identity of a particular data subject access requestor placing the first data subject access request; and (2) at least partially in response to verifying the identity of the particular data subject access requestor, automatically facilitating an update of personal data that an organization associated with the first webform is processing regarding the particular data subject access requestor.

Similarly, in particular embodiments, the system may be adapted for: (1) automatically verifying, by at least one computer processor, an identity of a particular data subject access requestor placing the first data subject access request; and (2) at least partially in response to verifying the identity of the particular data subject access requestor, automatically processing a request, made by the particular data subject access requestor, to opt out of having the organization use the particular data subject access requestor's personal information in one or more particular ways.

The system may, in various embodiments, be adapted for: (1) providing, by at least one computer processor, a webform creation tool that is adapted for receiving webform creation criteria from a particular user, the webform creation criteria comprising at least one criterion from a group consisting of: (A) a language that the form will be displayed in; (B) what information is to be requested from data subjects who use the webform to initiate a data subject access request; and (C) who any data subject access requests that are received via the webform will be routed to; and (2) executing the webform creation tool to create both the first webform and the second webform.

In light of the discussion above, although the Data Subject Access Request Routing Module 1000 is described as being adapted to, in various embodiments, route data subject access requests to particular individuals for handling, it should be understood that, in particular embodiments, this module may be adapted to process at least part of, or all of, particular data subject access requests automatically (e.g., without input from a human user). In such cases, the system may or may not route such automatically-processed requests to a designated individual for additional handling or monitoring. In particular embodiments, the system may automatically fulfill all or a portion of a particular DSAR request, automatically assign a transaction ID and/or authentication token to the automatically fulfilled transaction, and then display the completed DSAR transaction for display on a system dashboard associated with a particular responsible individual that would otherwise have been responsible for processing the DSAR request (e.g., an individual to whom the a webform receiving the DSAR would otherwise route DSAR requests). This may be helpful in allowing the human user to later track, and answer any questions about, the automatically-fulfilled DSAR request.

It should also be understood that, although the system is described, in various embodiments, as receiving DSAR requests via multiple webforms, each of which is located on a different website, the system may, in other embodiments, receive requests via only a single webform, or through any other suitable input mechanism other than a webform (e.g., through any suitable software application, request via SMS message, request via email, data transfer via a suitable API, etc.)

In various embodiments, the system may be adapted to access information needed to satisfy DSAR requests via one or more suitable data models. Such data models include those that are described in greater detail in U.S. patent application Ser. No. 15/996,208, filed Jun. 1, 2018, which, as noted above, is incorporated herein by reference. In various embodiments, the system is adapted to build and access such data models as described in this earlier-filed U.S. patent application.

As an example, in fulfilling a request to produce, modify, or delete, any of a data subject's personal information that is stored by a particular entity, the system may be adapted to access a suitable data model to identify any personal data of the data subject that is currently being stored in one or more computer systems associated with the particular entity. After using the data model to identify the data, the system may automatically process the data accordingly (e.g., by modifying or deleting it, and/or sharing it with the DSAR requestor).

### DSAR Prioritization Module

A DSAR Prioritization Module, according to various embodiments, is adapted for (1) executing the steps of receiving a data subject access request; (2) at least partially in response to receiving the data subject access request, obtaining metadata regarding a data subject of the data subject access request; (3) using the metadata to determine whether a priority of the DSAR should be adjusted based on the obtained metadata; and (4) in response to determining that the priority of the DSAR should be adjusted based on the obtained metadata, adjusting the priority of the DSAR.

The operation of various embodiments of the various software modules above is described in greater detail below. It should be understood that the various steps described herein may be executed, by the system, in any suitable order and that various steps may be omitted, or other steps may be added in various embodiments.

### Operation of Example Implementation

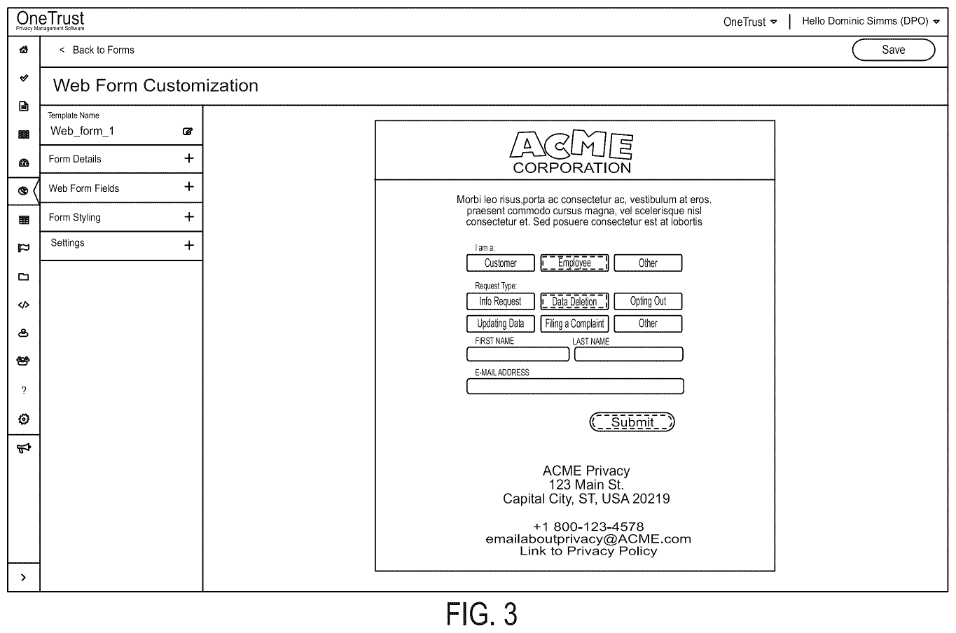

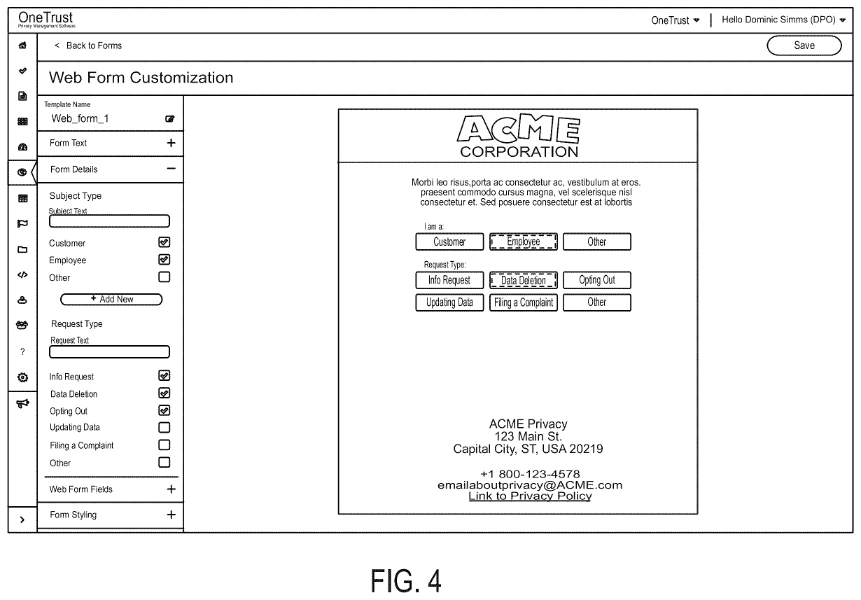

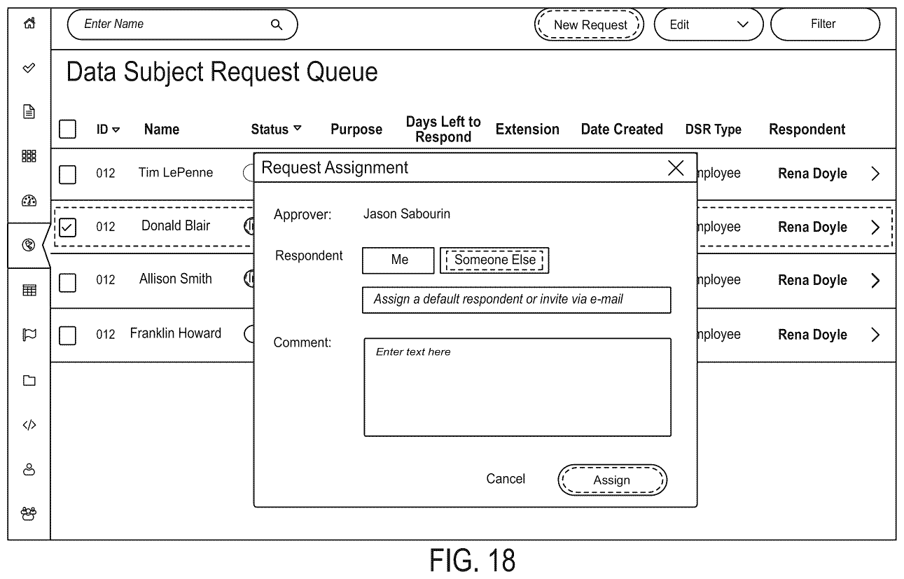

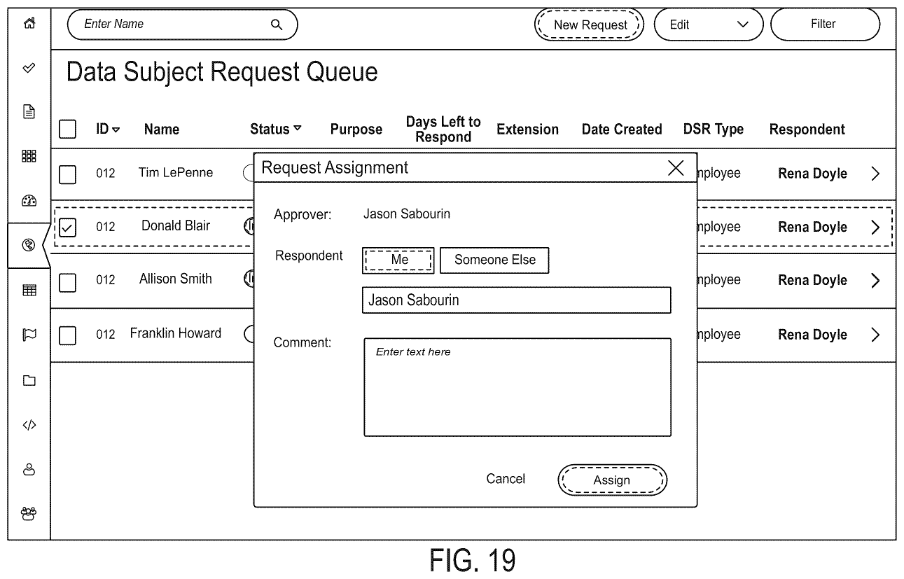

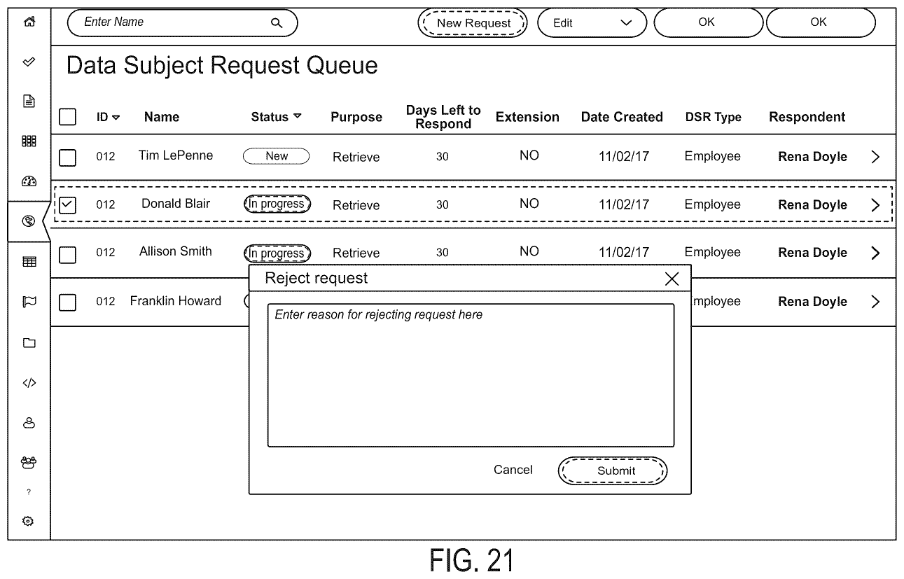

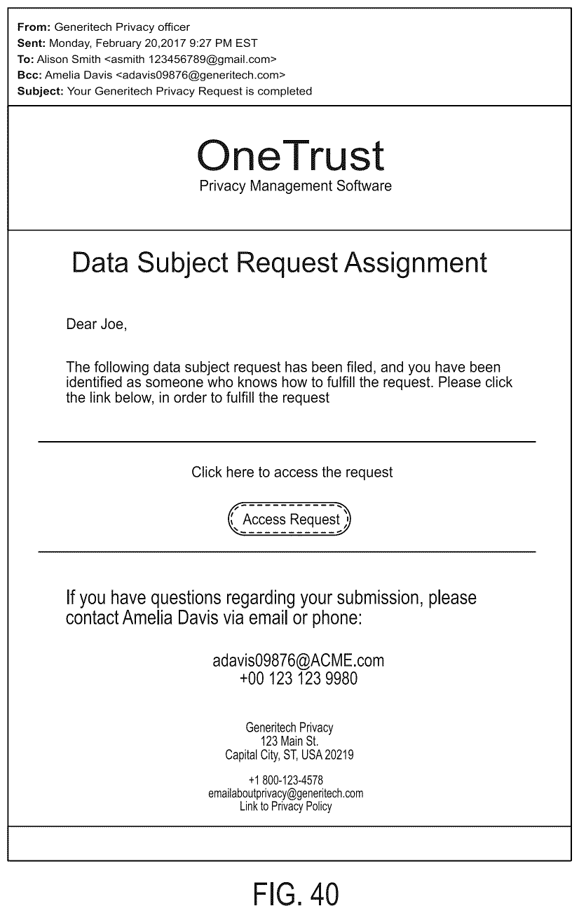

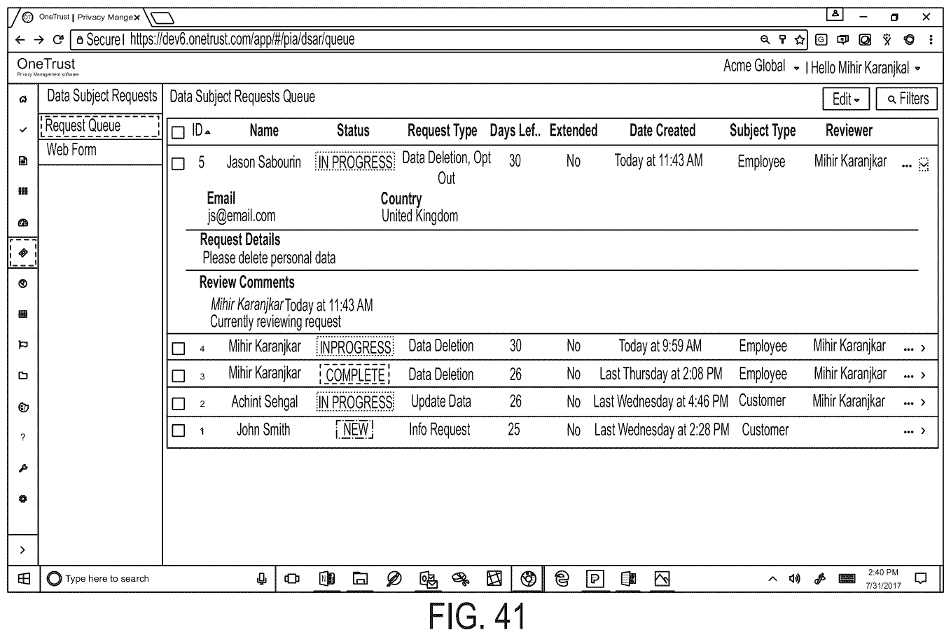

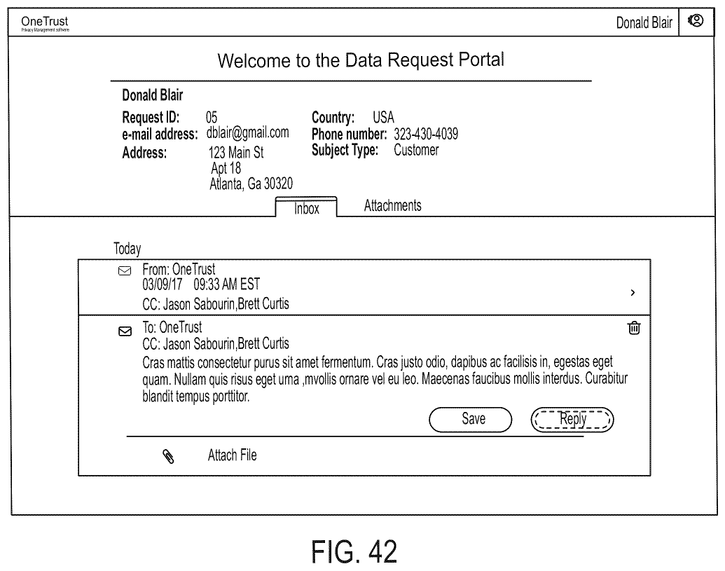

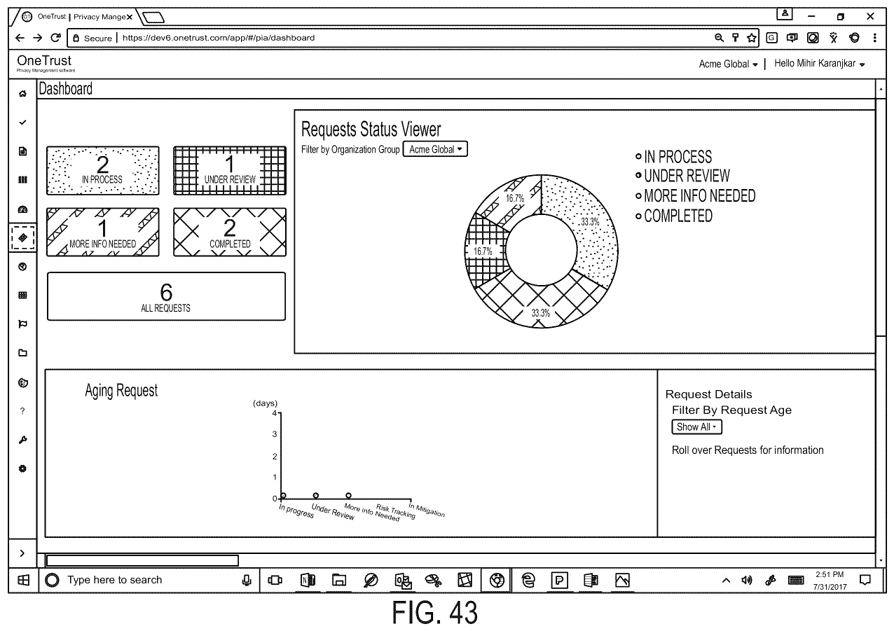

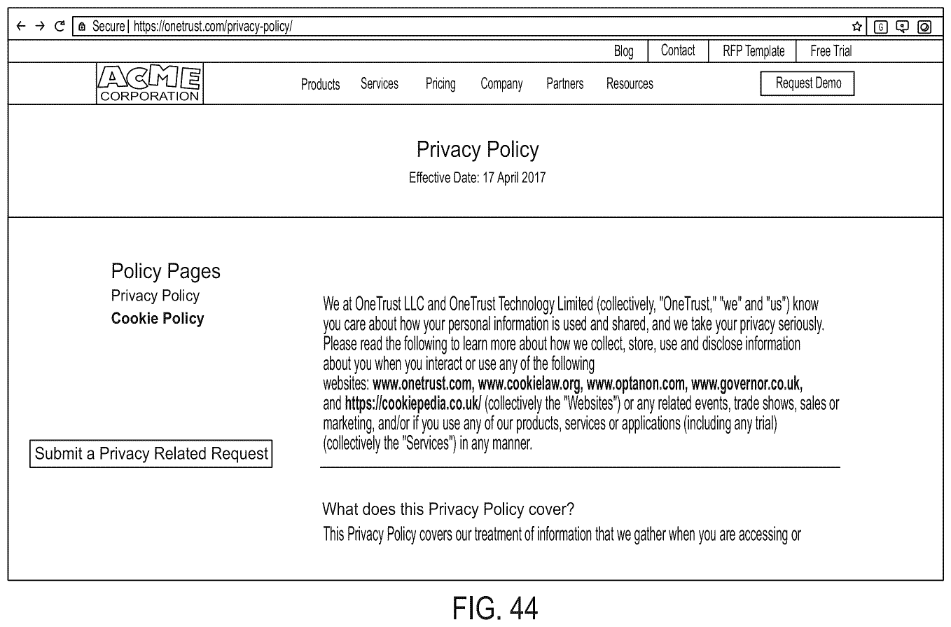

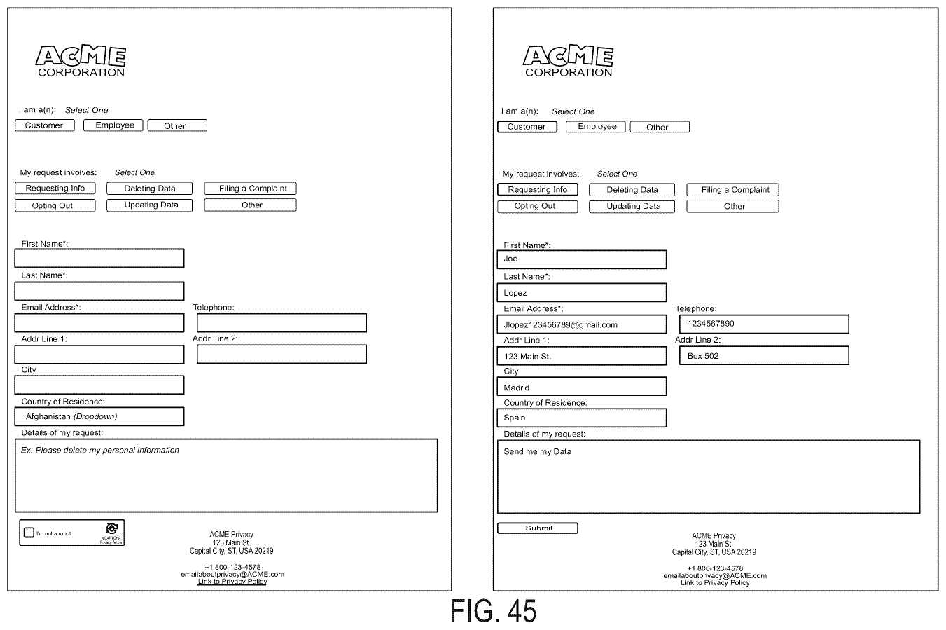

FIGS. 3-43 are screen shots that demonstrate the operation of a particular embodiment. FIGS. 3-6 show a graphical user interface (GUI) of an example webform construction tool. FIG. 3 shows a user working to design a webform called “Web_form 1”. As may be understood from the vertical menu shown on the left-hand side of the screen, the webform construction tool allows users to design a webform by: (1) specifying the details of the form (via the “Form Details” tab); (2) defining the fields that will be displayed on the webform (via the “Webform Fields” tab); (3) defining the styling of the webform (via the “Form Styling” tab); and (4) defining various settings associated with the webform (via the “Settings” tab). As shown in FIGS. 4-6, the user may also specify text to be displayed on the webform (e.g., via a “Form Text” tab).

FIG. 4 shows that, by selecting the “Form Details” tab, the user may define which answers a requestor will be able to specify on the webform in response to prompts for information regarding what type of individual they are (customer, employee, etc.) and what type of request they are making via the webform. Example request types include: (1) a request for all personal data that an organization is processing for the data subject (a copy of the personal data in a commonly used, machine-readable format); (2) a request for all such personal data to be deleted; (3) a request to update personal data that the organization is storing for the data subject; (4) a request to opt out of having the organization use the individual's personal information in one or more particular ways (e.g., per the organization's standard business practices); (5) file a complaint; and/or (6) other.

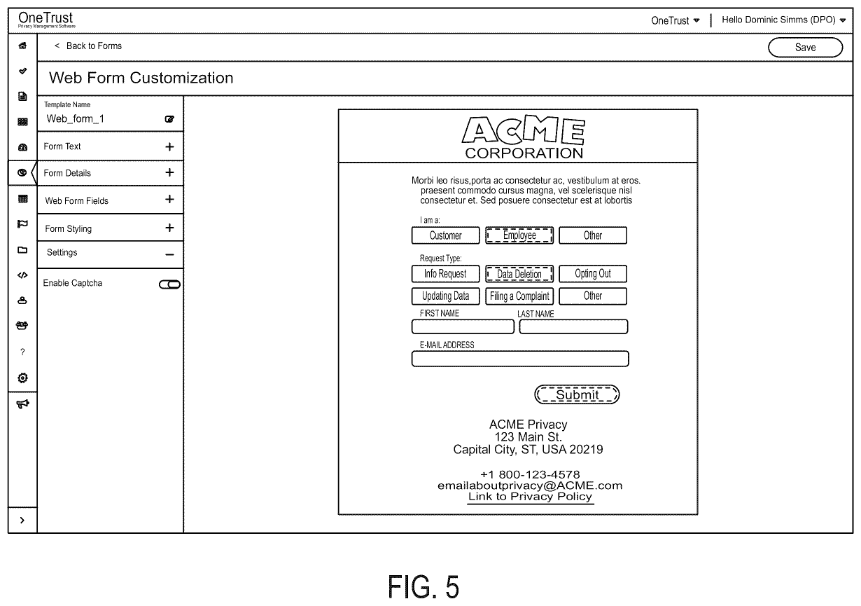

FIG. 5 shows that, by selecting the “Settings” tab, the user may specify various system settings, such as whether Captcha will be used to verify that information is being entered by a human, rather than a computer.

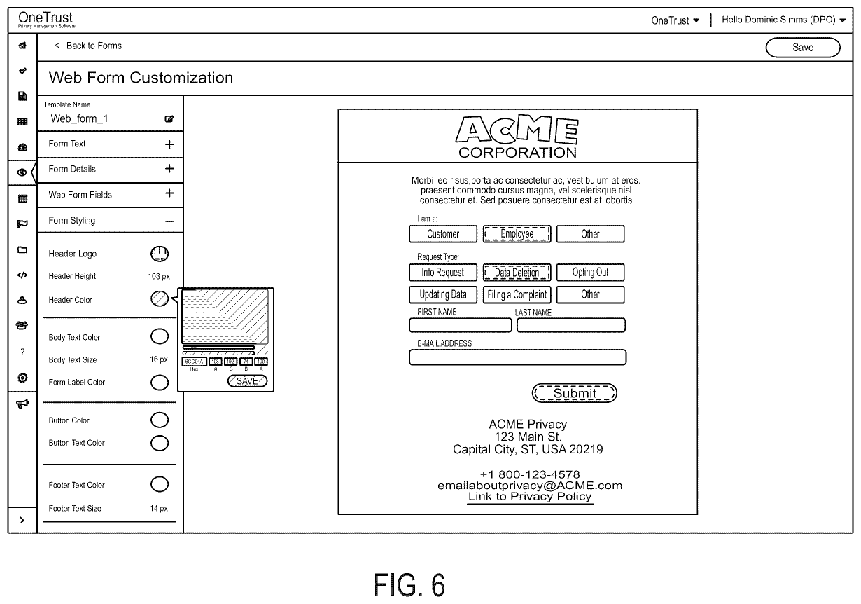

FIG. 6 shows that, by selecting the Form Styling tab, the user may specify the styling of the webform. The styling may include, for example: (1) a header logo; (2) header height; (3) header color; (4) body text color; (5) body text size; (6) form label color; (7) button color; (8) button text color; (9) footer text color; (10) footer text size; and/or any other suitable styling related to the webform.

In other embodiments, the system is configured to enable a user to specify, when configuring a new webform, what individual at a particular organization (e.g., company) will be responsible for responding to requests made via the webform. The system may, for example, enable the user to define a specific default sub-organization (e.g., within the organization) responsible for responding to DSAR's submitted via the new webform. As such, the system may be configured to automatically route a new DSAR made via the new webform to the appropriate sub-organization for processing and fulfillment. In various embodiments, the system is configured to route one or more various portions of the DSAR to one or more different sub-organizations within the organization for handling.

In particular embodiments, the system may include any suitable logic for determining how the webform routes data subject access requests. For example, the system may be adapted to determine which organization or individual to route a particular data subject access request to based, at least in part, on one or more factors selected from a group consisting of: (1) the data subject's current location; (2) the data subject's country of residence; (3) the type of request being made; (4) the type of systems that contain (e.g., store and/or process) the user's personal data (e.g., in ADP, Salesforce, etc.); or any other suitable factor.

In particular embodiments, the system is configured to enable a user generating webforms to assign multiple webforms to multiple different respective suborganizations within an organization. For example, an organization called ACME, Inc. may have a website for each of a plurality of different brands (e.g., sub-organizations) under which ACME sells products (e.g., UNICORN Brand T-shirts, GRIPP Brand Jeans, etc.). As may be understood in light of this disclosure, each website for each of the particular brands may include an associated webform for submitting DSAR's (either a webform directly on the website, or one that is accessible via a link on the website). Each respective webform may be configured to route a DSAR made via its associated brand website to a particular sub-organization and/or individuals within ACME for handling DSAR's related to the brand.

As noted above, after the user uses the webform construction tool to design a particular webform for use on a particular web page, the webform construction tool generates code (e.g., HTML code) that may be pasted into the particular web page to run the designed webform page. In particular embodiment, when pasted into the particular web page, the code generates a selectable button on the web page that, when selected, causes the system to display a suitable DSAR request webform.

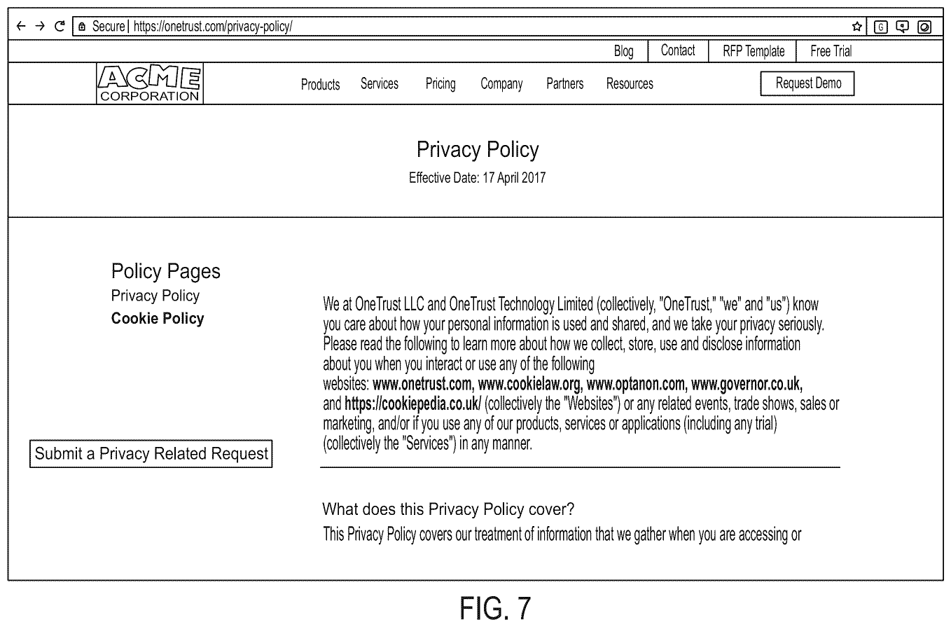

FIG. 7 shows the privacy webpage of a company (e.g., the ACME corporation). As shown in this figure, a requestor may submit a DSAR by selecting a “Submit a Privacy Related Request” button on the web page.

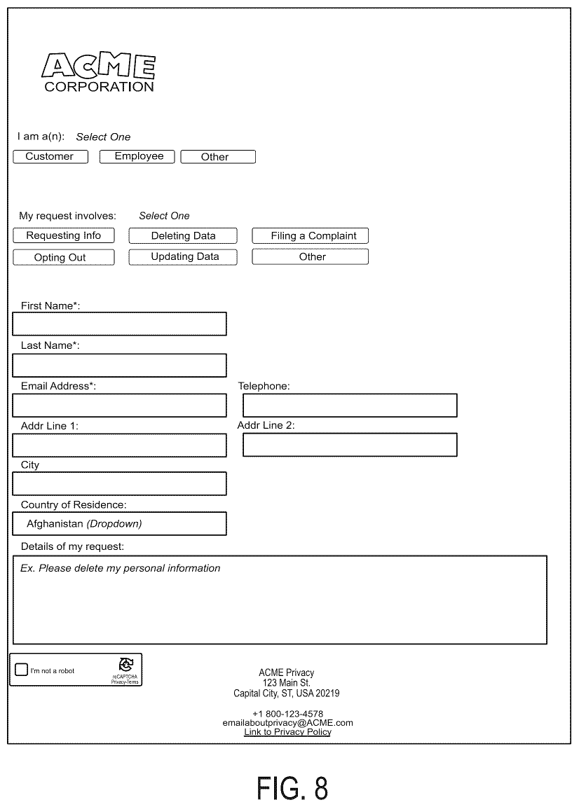

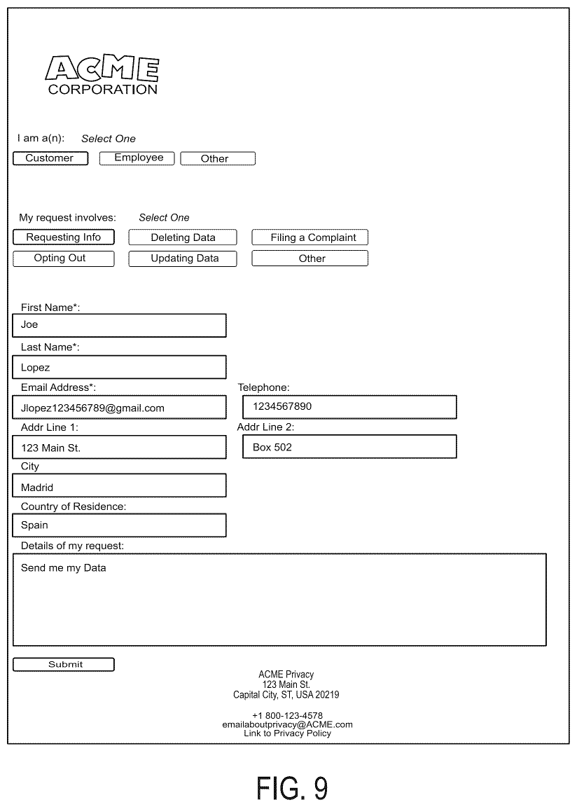

FIG. 8 shows a webform that is displayed after a requestor selects the “Submit a Privacy Related Request” button on the privacy webpage of FIG. 7. As may be understood from this figure, the requestor may complete the webform by specifying which type of user they are, and what type of request they are making. The webform also asks the requestor to provide enough personal information to confirm their identity (e.g., and fulfill the request). As shown in this figure, the system may prompt a user submitting a DSAR to provide information for the user such as, for example: (1) what type of requestor the user is (e.g., employee, customer, etc.); (2) what the request involves (e.g., requesting info, opting out, deleting data, updating data, etc.); (3) first name; (4) last name; (5) email address; (6) telephone number; (7) home address; (8) one or more other pieces of identifying information; and/or (9) one or more details associated with the request. FIG. 9 shows an example populated version of the webform.

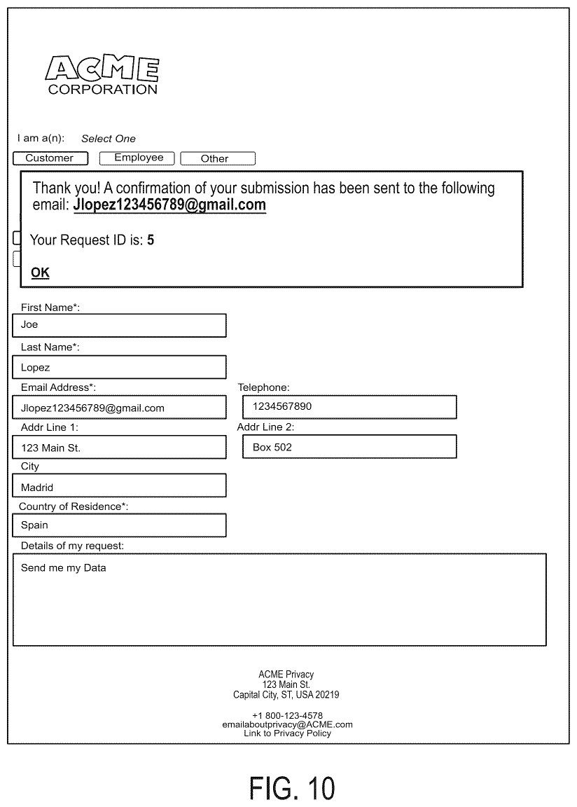

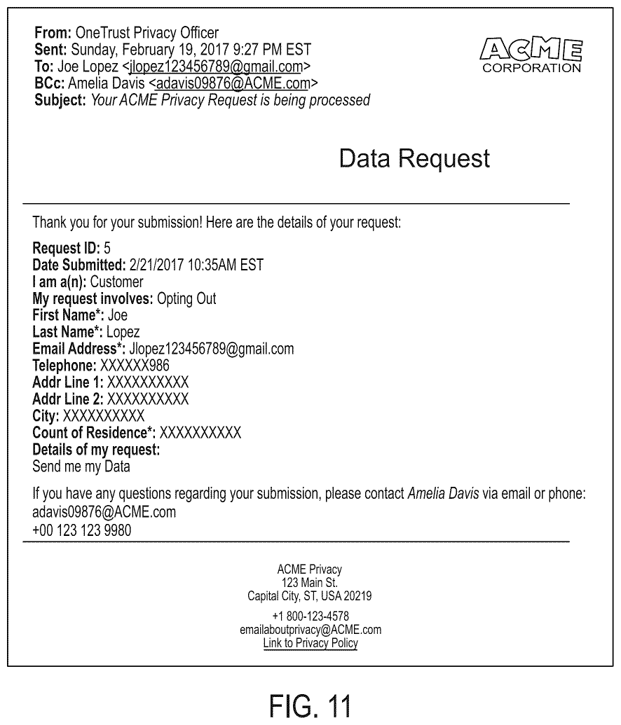

As shown in FIG. 10, after a requestor completes the webform and selects a “submit” indicia, the system displays a message to the requestor indicating that their DSAR has been successfully submitted. The system also displays a Request ID associated with the request. In response to the requestor successfully submitting the request, the system may also send an email (or other suitable communication) to the requestor confirming the request. An example of a suitable confirmation email is shown in FIG. 11.

In various embodiments, the system includes a dashboard that may be used by various individuals within an organization (e.g., one or more privacy officers of an organization) to manage multiple DSAR requests. As discussed above, the dashboard may display DSAR's submitted, respectively, to a single organization, any of multiple different sub-organizations (divisions, departments, subsidiaries etc.) of a particular organization, and/or any of multiple independent organizations. For example, the dashboard may display a listing of DSAR's that were submitted from a parent organization and from the parent organization's U.S. and European subsidiaries. This may be advantageous, for example, because it may allow an organization to manage all DSAR requests of all of its sub-organizations (and/or other related organizations) centrally.

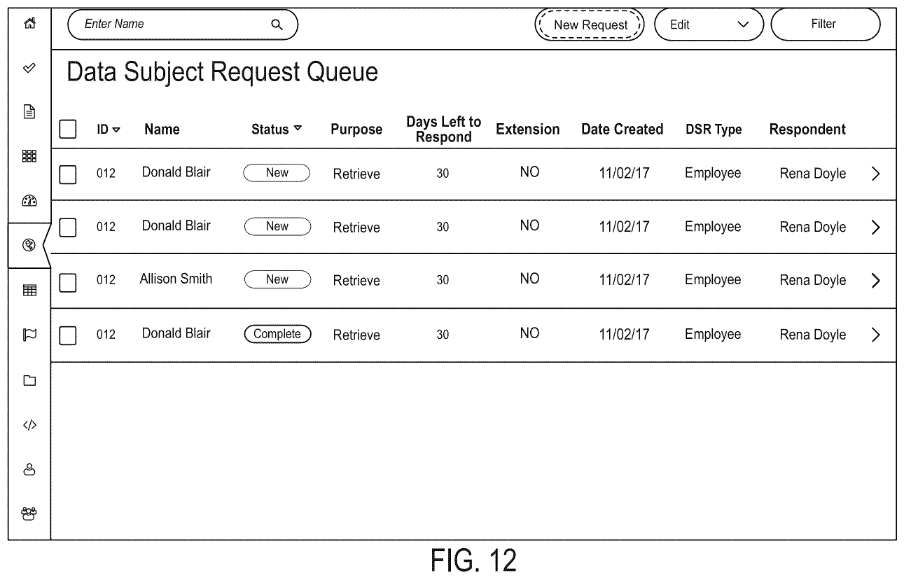

FIGS. 12-23, 25-27, 29-34, and 41-43 depict various example user-interface screens of a DSAR request-management dashboard. As may be understood from FIG. 12, after an appropriate user (e.g., a privacy officer associated with a particular organization) logs into the system, the system may display a Data Subject Request Queue that may, for example, display a listing of all data subject access requests that the appropriate individual has been designated to process. As shown in FIG. 12, each data subject access request may be represented by a respective row of information that includes: (1) an ID number for the request; (2) the name of the data subject who has submitted the request; (3) the status of the request; (4) the number of days that are left to respond to the request (e.g., according to applicable laws and/or internal procedures); (5) an indication as to whether the deadline to respond to the request has been extended; (6) a creation date of the request; (7) an indication of the type of requestor that submitted the request (customer, employee, etc.); (8) the name of the individual who has been assigned to process the request (e.g., the respondent). This screen may also include selectable “Edit” and “Filter” buttons that respectively facilitate acting on and filtering the various requests displayed on the page.

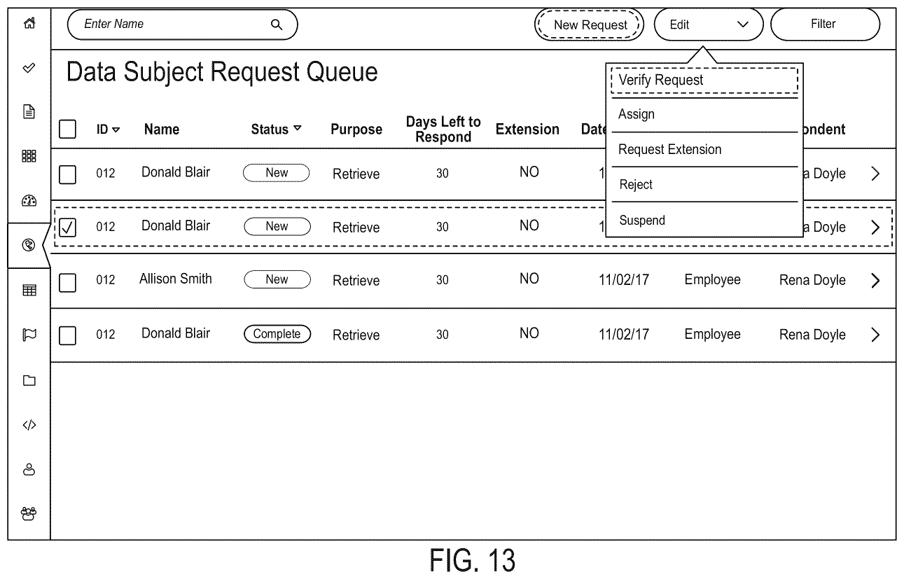

As shown in FIG. 13, in response to a respondent selecting the edit button while a particular DSAR is highlighted, the system displays a dropdown menu allowing the respondent to select between taking the following actions: (1) verify the request; (2) assign the request to another individual; (3) request an extension; (4) reject the request; or (5) suspend the request.

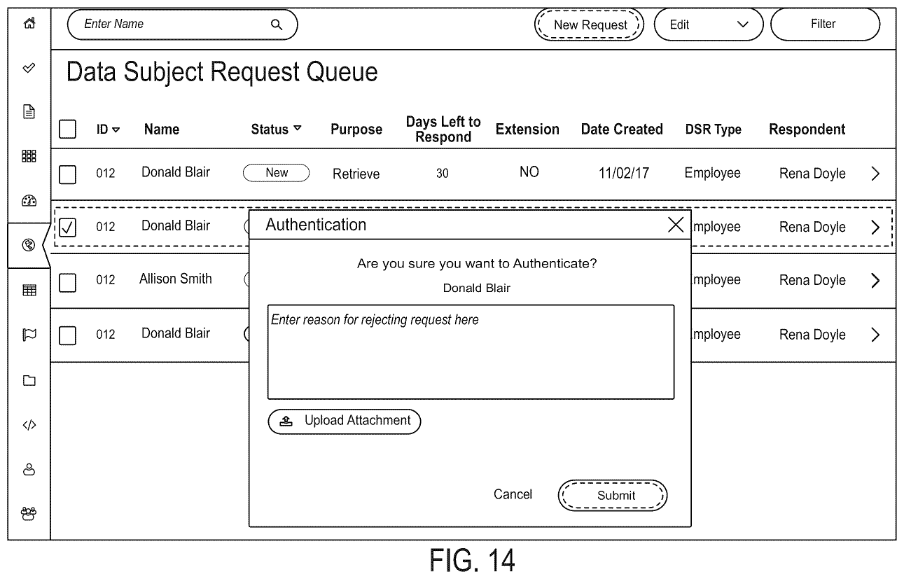

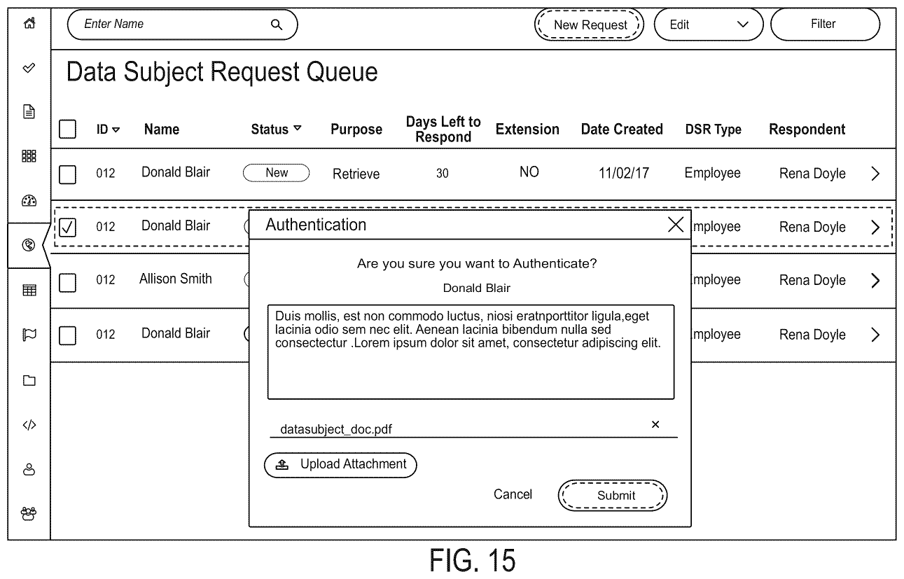

FIGS. 14 and 15 show a message that the system displays to the respondent in response to the respondent selecting the “verify” option. As shown in this figure, the system prompts the respondent to indicate whether they are sure that they wish to authenticate the request. The system also presents an input field where the respondent can enter text to be displayed to the requestor along with a request for the requestor to provide information verifying that they are the data subject associated with the request. After the respondent populates the input field, they may submit the request by selecting a “Submit” button.

In particular embodiments, the input field may enable the respondent to provide one or more supporting reasons for a decision, by the respondent, to authenticate the request. The respondent may also upload one or more supporting documents (such as an attachment). The supporting documents or information may include, for example, one or more documents utilized in confirming the requestor's identity, etc.

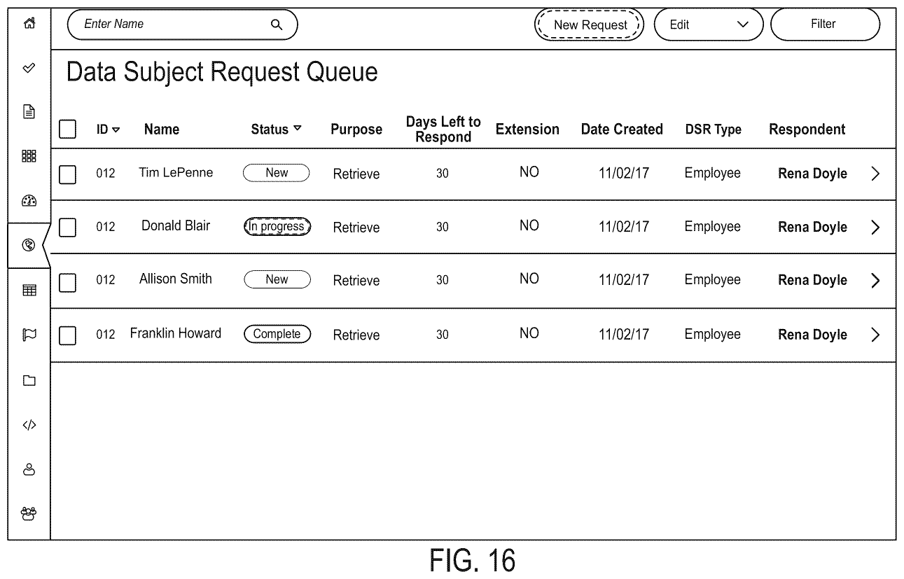

In response to the respondent selecting the Submit button, the system changes the status of the request to “In Progress” and also changes the color of the request's status from orange to blue (or from any other suitable color to any different suitable color)—see FIG. 16. The system also generates and sends a message (e.g., an electronic or paper message) to the requestor asking them to submit information verifying the request. The message may include the text that the respondent entered in the text box of FIG. 14.

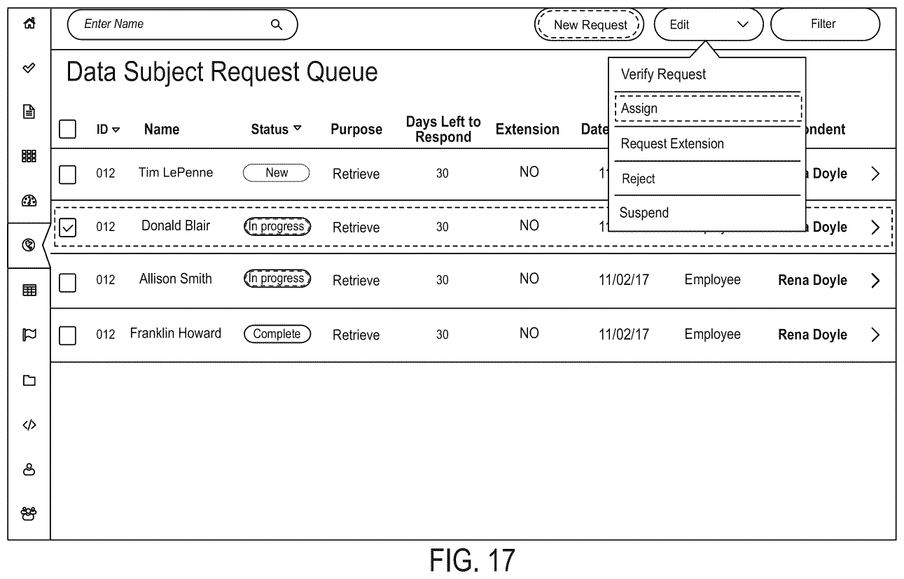

As shown in FIGS. 17-19, in response to a respondent selecting the “Edit” button and then selecting the “Assign” indicia from the displayed dropdown menu, the system displays a Request Assignment interface that allows a respondent to indicate who the request should be assigned to. For example, the respondent may indicate that they will be handling the request, or assign the request to another suitable individual, who may, for example, then be designated as the respondent for the request. If the respondent assigns the request to another individual for handling, the respondent may also provide an email address or other correspondence information for the individual. The Request Assignment interface includes a comment box for allowing a respondent to add a message to the individual that the assignment will be assigned to regarding the assignment. In response to the respondent selecting the “Assign” button, the system assigns the request to the designated individual for handling. If the request has been assigned to another, designated individual, the system automatically generates and sends a message (e.g., an electronic message such as an email or SMS message) to the designated individual informing them of the assignment.

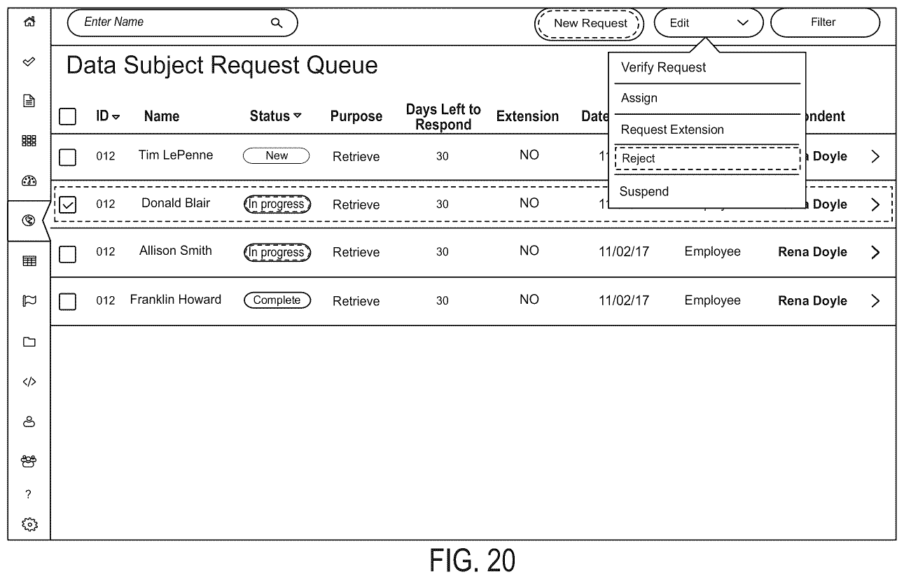

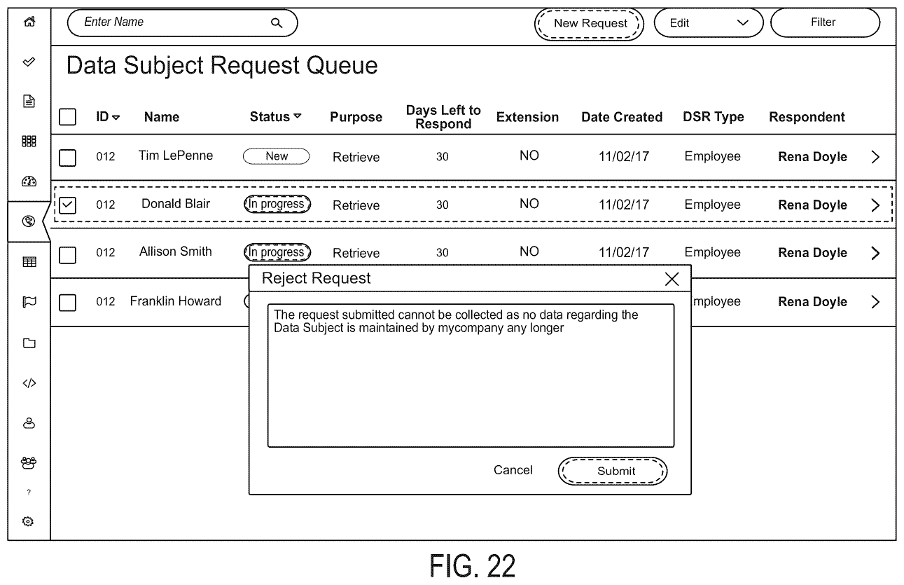

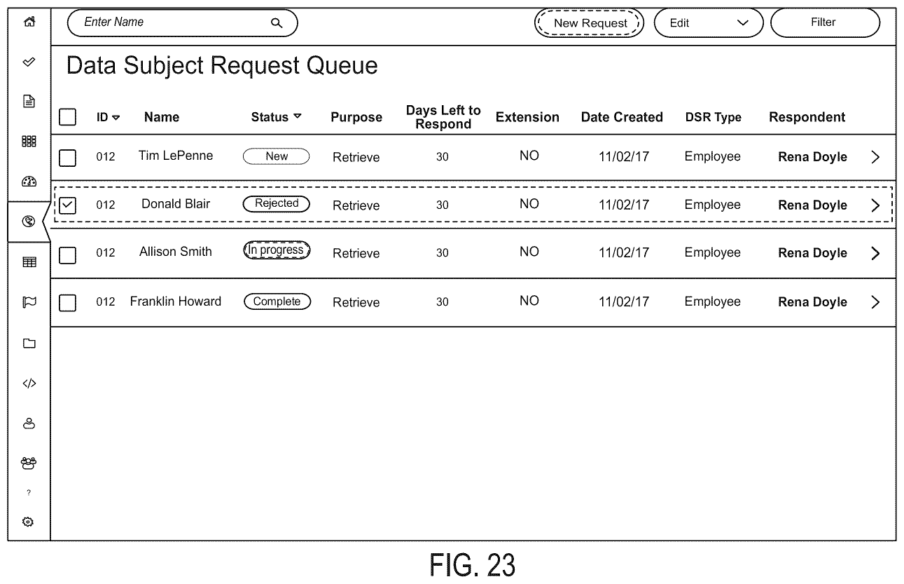

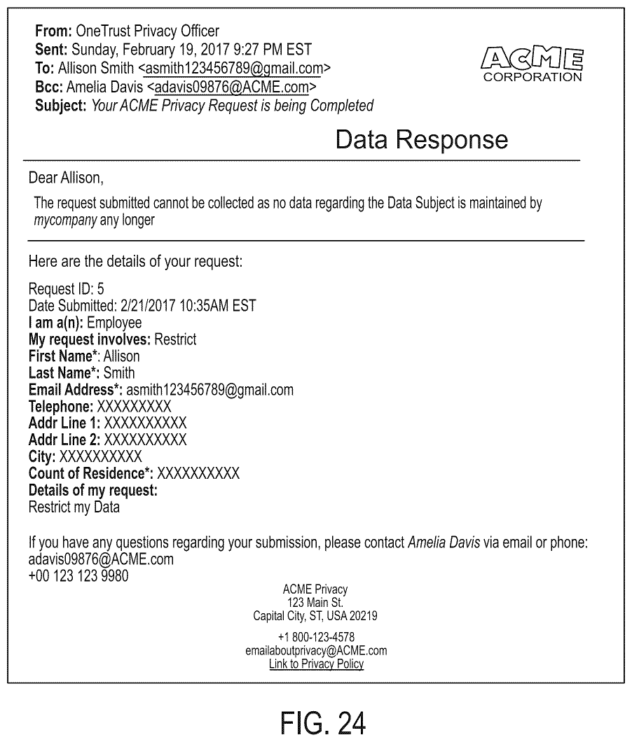

As shown in FIGS. 20-22, in response to a respondent selecting the “Edit” button and then selecting the “Reject” indicia from the displayed dropdown menu, the system displays a Reject Request interface. This interface includes a comment box for allowing a respondent to add a message to the requestor as to why the request was rejected. In response to the respondent selecting the “Submit” button, the system changes the status of the request to “Rejected” and changes the color of the request's status indicator to red (See FIG. 23). The system may also automatically generate a message (e.g., an electronic or paper message) to the requestor notifying them that their request has been rejected and displaying the text that the respondent entered into the Reject Request interface of FIG. 22. An example of such a message is shown in FIG. 24.

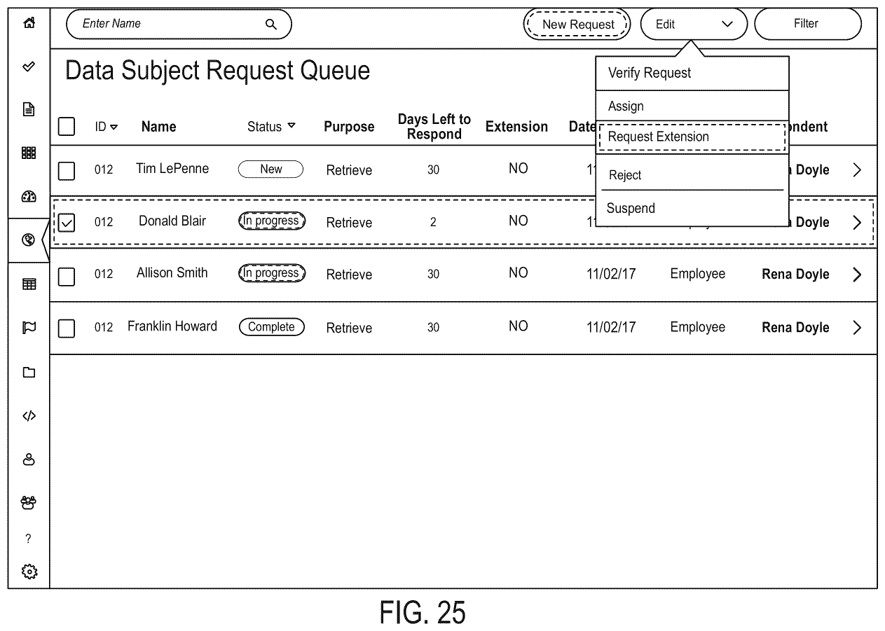

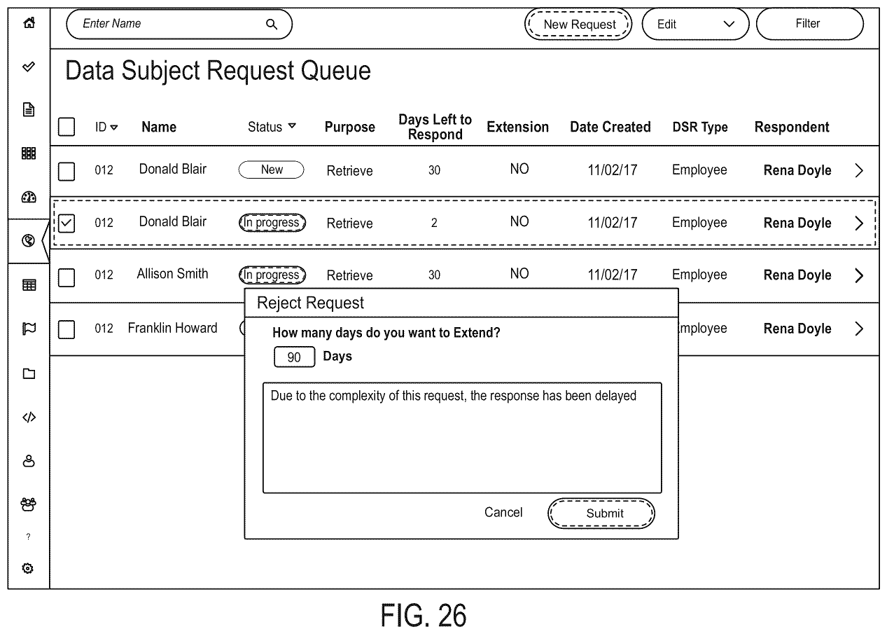

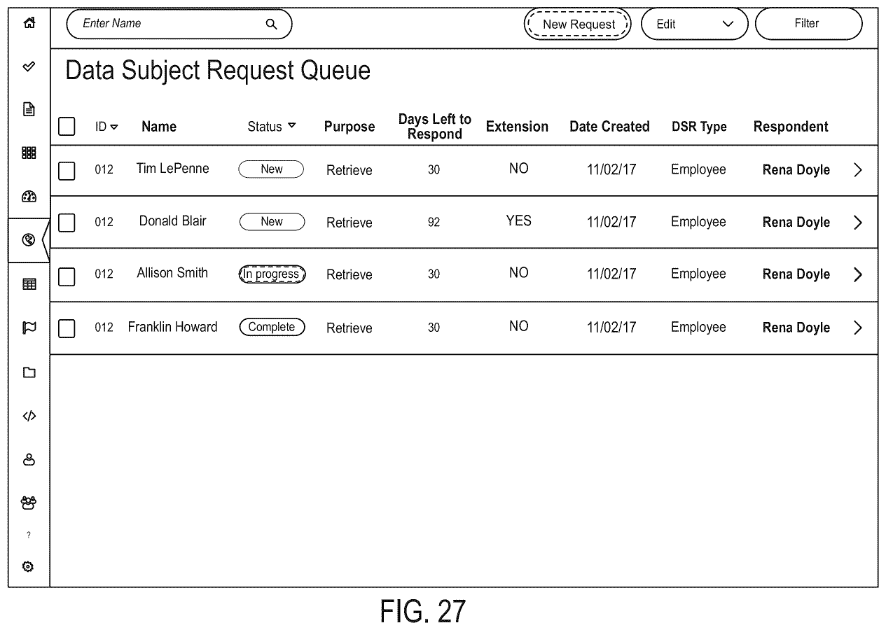

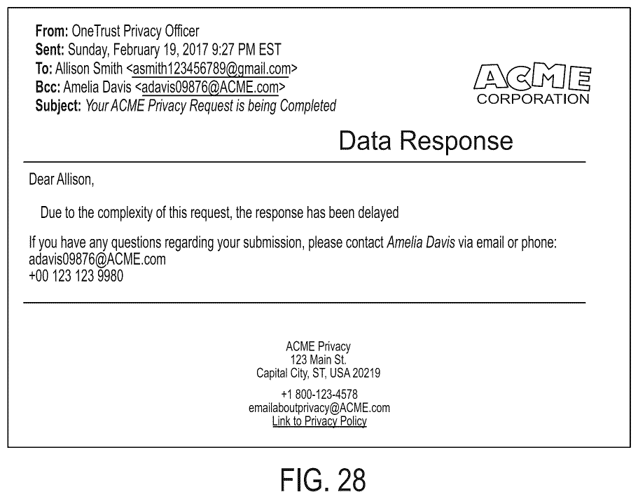

As shown in FIGS. 25-26, in response to a respondent selecting the “Edit” button and then selecting the “Request Extension” indicia from the displayed dropdown menu, the system displays a Request Extension interface. This includes a text box for allowing a user to indicate the number of days for which they would like to extend the current deadline for responding to the request. For example, the dialog box of FIG. 26 shows the respondent requesting that the current deadline be extended by 90 days. In response to the respondent entering a desired extension duration and selecting the “Submit” button, the system updates the deadline in the system's memory (e.g., in an appropriate data structure) to reflect the extension. For instance, in the example of FIG. 26, the system extends the deadline to be 90 days later than the current deadline. As shown in FIG. 27, the system also updates the “Days Left to Respond” field within the Data Subject Request Queue to reflect the extension (e.g., from 2 days from the current date to 92 days from the current date). As shown in FIG. 28, the system may also generate an appropriate message (e.g., an electronic, such as an email, or a paper message) to the requestor indicating that the request has been delayed. This message may provide a reason for the delay and/or an anticipated updated completion date for the request.

In particular embodiments, the system may include logic for automatically determining whether a requested extension complies with one or more applicable laws or internal policies and, in response, either automatically grant or reject the requested extension. For example, if the maximum allowable time for replying to a particular request is 90 days under the controlling laws and the respondent requests an extension that would result in the fulfillment of the request 91 or more days from the date that the request was submitted, the system may automatically reject the extension request. In various embodiments, the system may also communicate, to the respondent (e.g., via a suitable electronic message or text display on a system user interface) an explanation as to why the extension request was denied, and/or a maximum amount of time (e.g., a maximum number of days) that the deadline may be extended under the applicable laws or policies. In various embodiments, if the system determines that the requested extension is permissible under the applicable laws and/or policies, the system may automatically grant the extension.

In other embodiments, the system may be configured to automatically modify a length of the requested extension to conform with one or more applicable laws and/or policies. For example, if the request was for a 90-day extension, but only a 60 day extension is available under the applicable laws or regulations, the system may automatically grant a 60-day extension rather than a 90 day extension. The system may be adapted to also automatically generate and transmit a suitable message (e.g., a suitable electronic or paper communication) notifying them of the fact that the extension was granted for a shorter, specified period of time than requested.

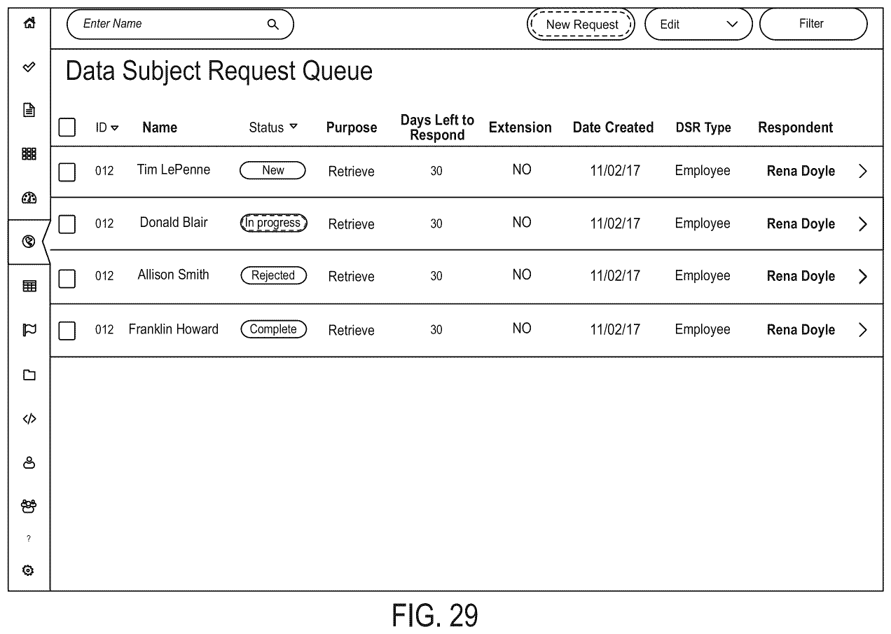

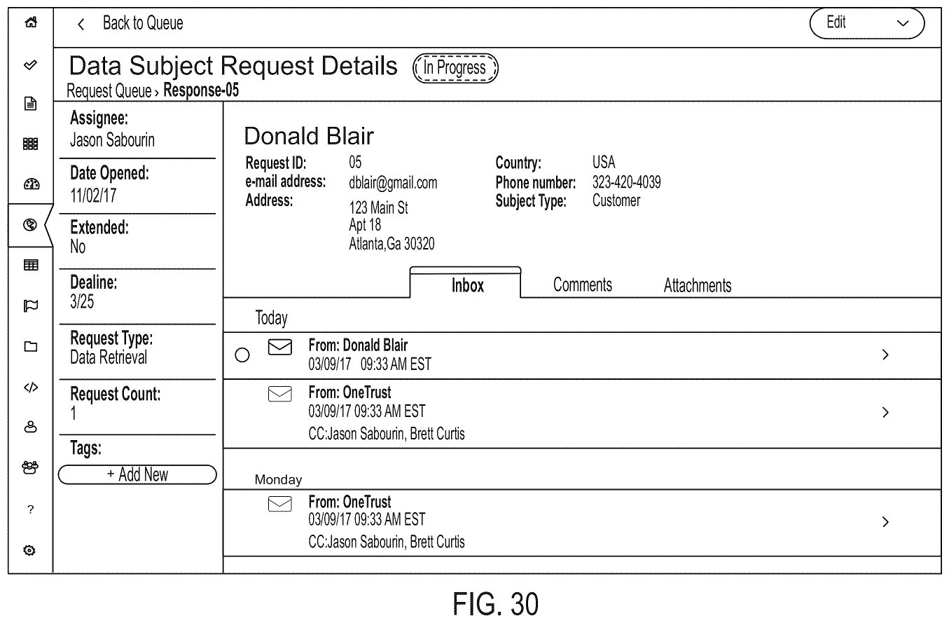

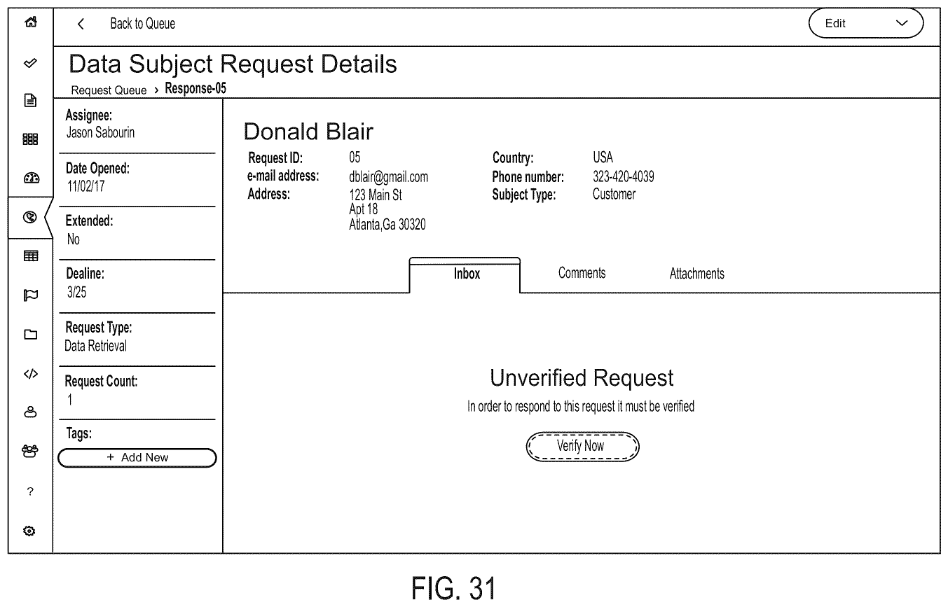

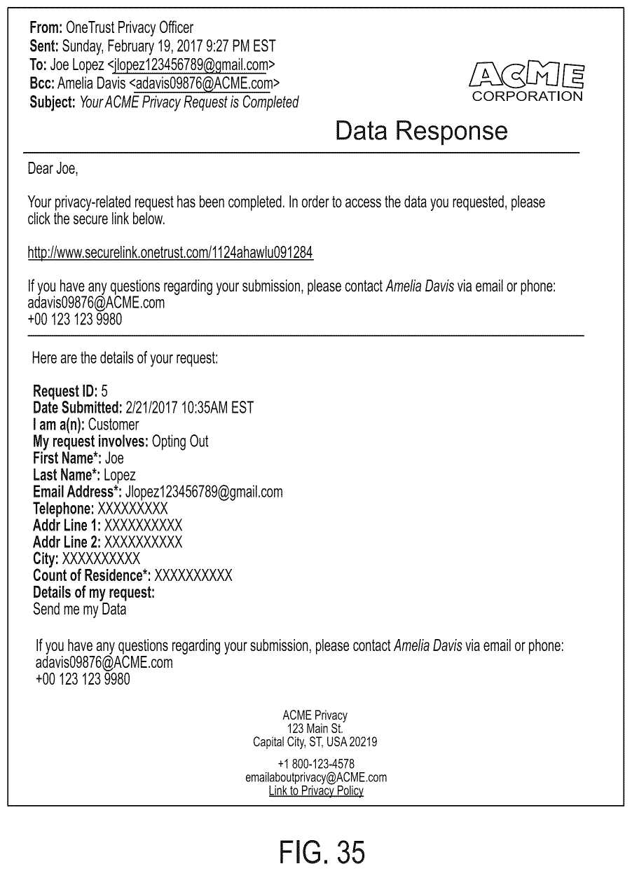

As shown in FIGS. 29-34, a respondent may obtain additional details regarding a particular request by selecting (e.g., clicking on) the request on the Data Subject Request Queue screen. For example, FIG. 30 shows a Data Subject Request Details screen that the system displays in response to a respondent selecting the “Donald Blair” request on the user interface screen of FIG. 35. As shown in FIG. 30, the Data Subject Request Details screen shows all correspondence between the organization and the requesting individual regarding the selected data subject access request. As may be understood from FIG. 31, when a respondent selects a particular correspondence (e.g., email), the system displays the correspondence to the respondent for review or other processing.

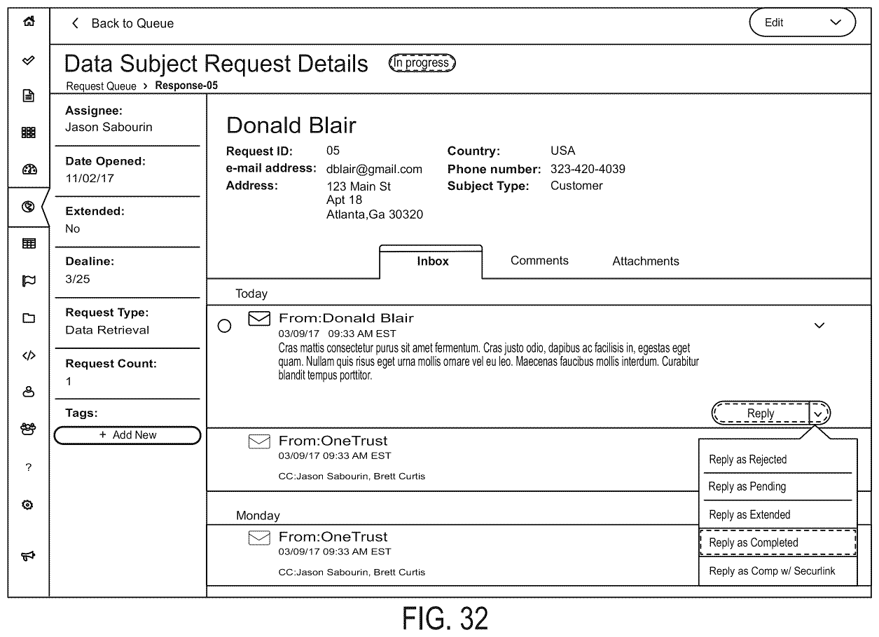

As shown in FIG. 32, in various embodiments, the system may provide a selectable “Reply” indicia that allows the respondent to reply to particular correspondence from an individual. As may be understood from this figure, in response to the respondent selecting the “Reply” indicia, the system may display a dropdown menu of various standard replies. For example, the dropdown menu may provide the option of generating a reply to the requestor indicating that the request has been rejected, is pending, has been extended, or that the request has been completed.

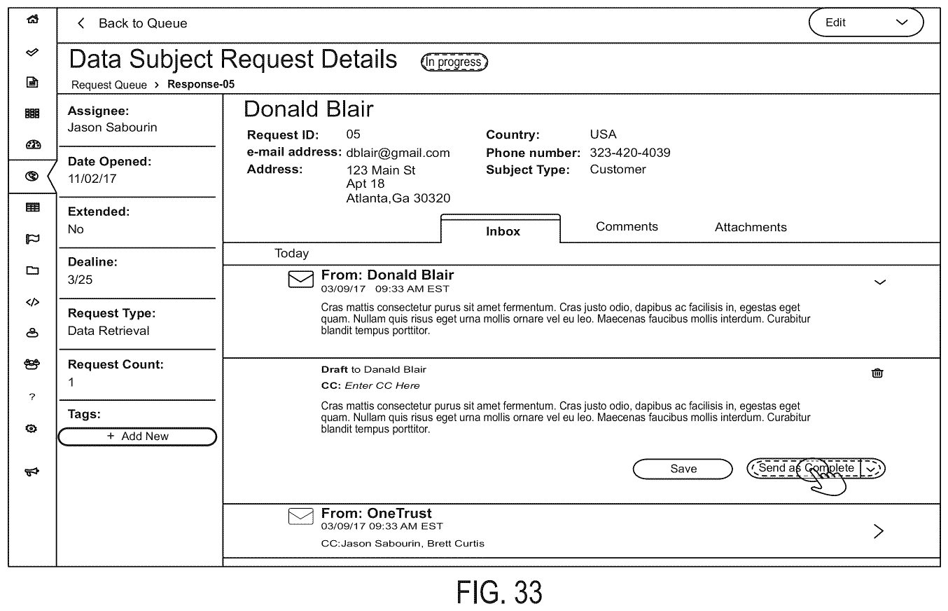

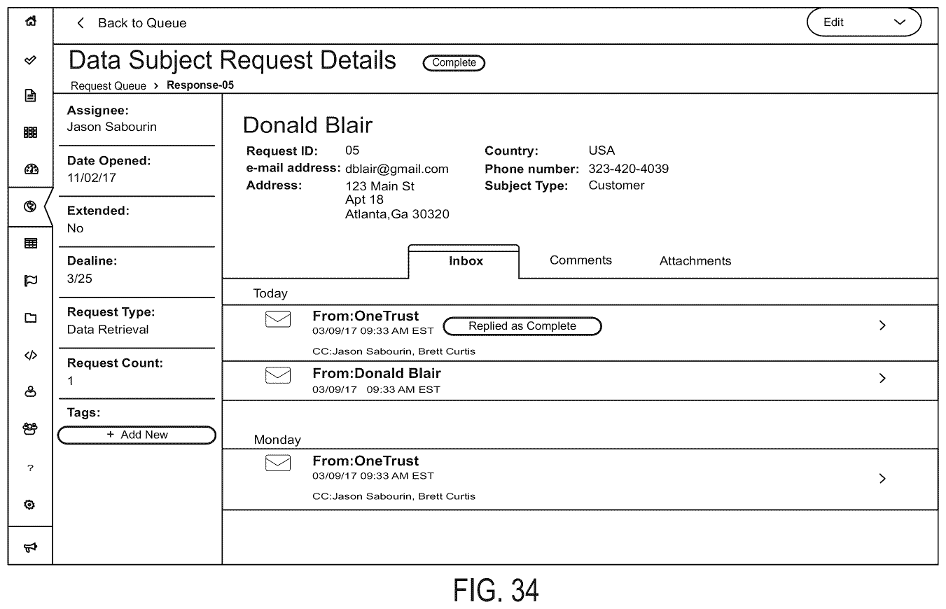

As shown in FIG. 33, in response to the respondent selecting “Reply as Completed”, the system may generate a draft email to the requestor explaining that the request has been completed. The respondent may then edit this email and send the edited correspondence (e.g., via email) to the requestor by selecting a “Send as Complete” indicia. As shown in FIG. 34, the system may, in response, display an indicator adjacent the correspondence indicating that the correspondence included a reply indicating that the request was complete. This may be useful in allowing individuals to understand the contents of the correspondence without having to open it.

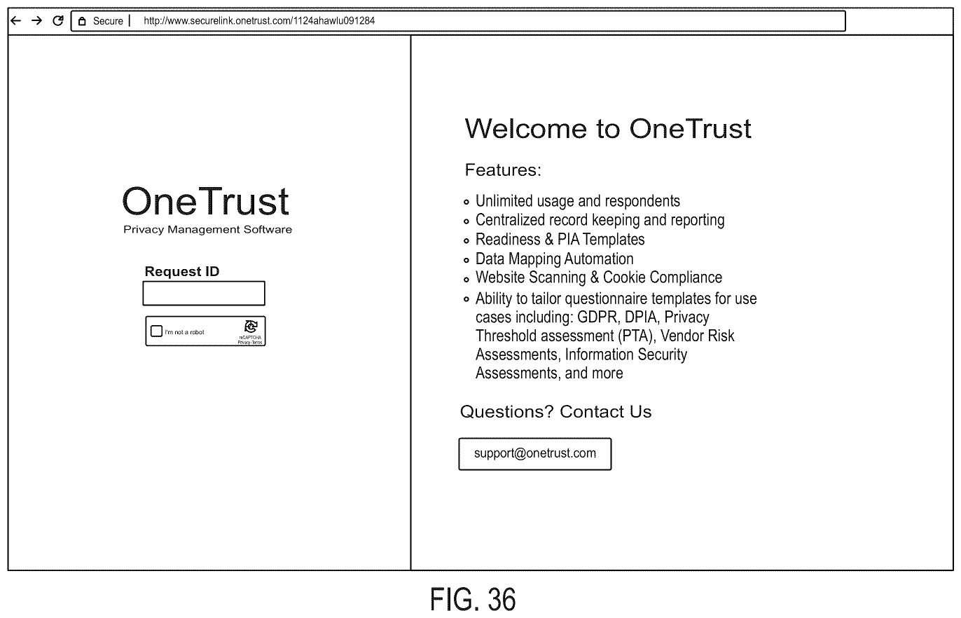

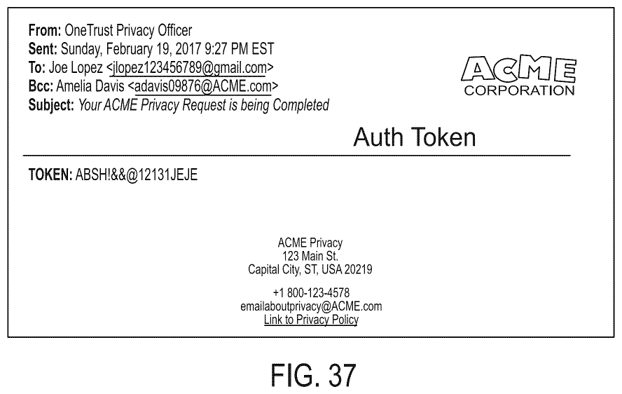

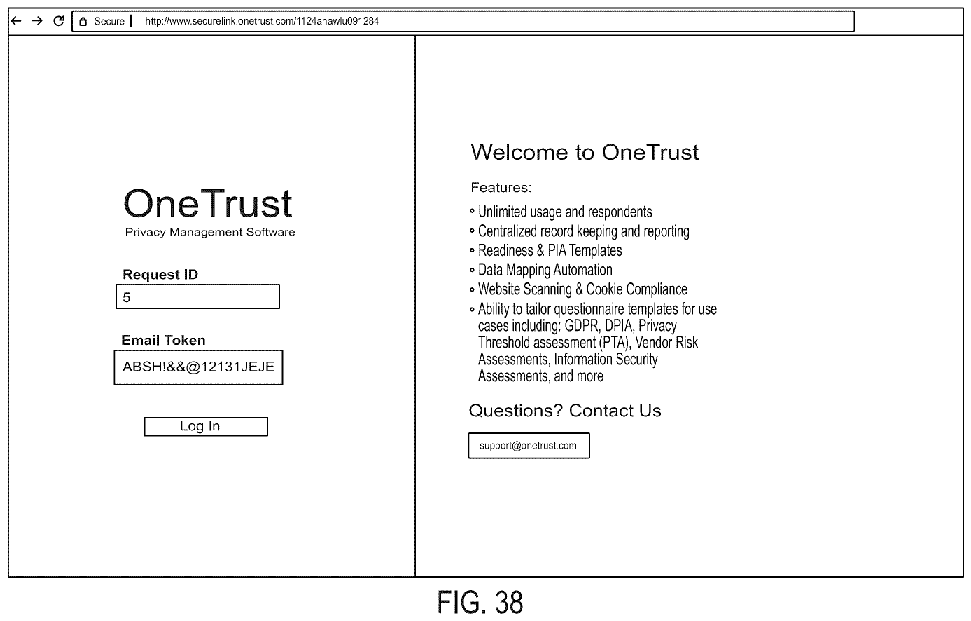

FIG. 35 shows an example email automatically generated by the system in response to the respondent selecting “Reply as Completed” on the screen shown in FIG. 32. As shown in FIG. 35, the correspondence may include a secure link that the requestor may select to access the data that was requested in the DSAR. In particular embodiments, the link is a link to a secure website, such as the website shown in FIG. 36, that provides access to the requested data (e.g., by allowing a user to download a .pdf file, or other suitable file, that includes the requested data). As shown in FIG. 36, the website may require multiple pieces of data to verify that the requestor is permitted to access the site. For example, in order to access the website, the requestor may be required to provide both the unique ID number of the request, and an authentication token, which the system may send to the user via email-See FIGS. 37 and 38.

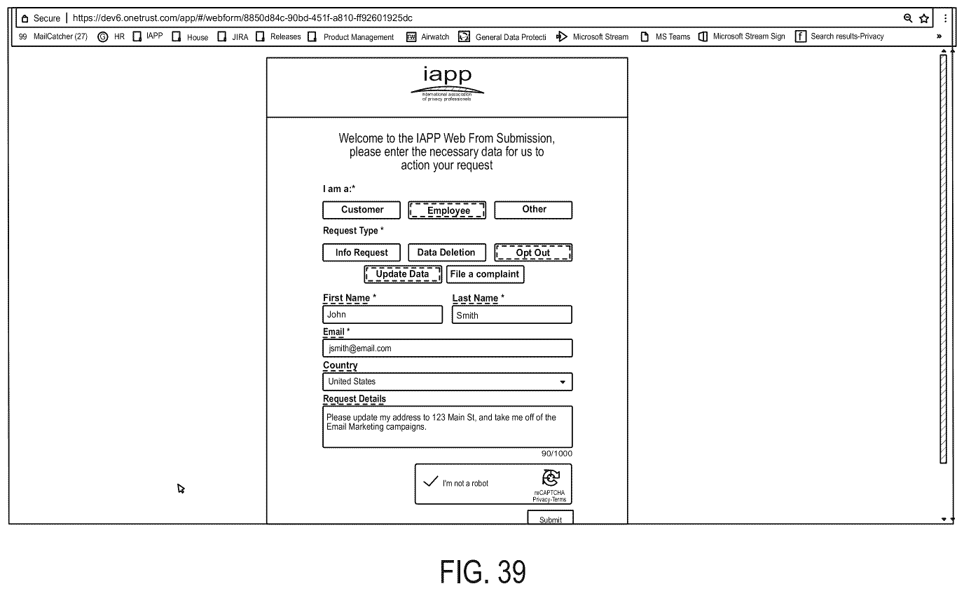

FIGS. 39-43 are computer screen shots that depict additional user interfaces according to various embodiments.

### Additional Concepts

### Intelligent Prioritization of DSAR's

In various embodiments, the system may be adapted to prioritize the processing of DSAR's based on metadata about the data subject of the DSAR. For example, the system may be adapted for: (1) in response to receiving a DSAR, obtaining metadata regarding the data subject; (2) using the metadata to determine whether a priority of the DSAR should be adjusted based on the obtained metadata; and (3) in response to determining that the priority of the DSAR should be adjusted based on the obtained metadata, adjusting the priority of the DSAR.

Examples of metadata that may be used to determine whether to adjust the priority of a particular DSAR include: (1) the type of request, (2) the location from which the request is being made, (3) current sensitivities to world events, (4) a status of the requestor (e.g., especially loyal customer), or (5) any other suitable metadata.

In various embodiments, in response to the system determining that the priority of a particular DSAR should be elevated, the system may automatically adjust the deadline for responding to the DSAR. For example, the system may update the deadline in the system's memory and/or modify the “Days Left to Respond” field (See FIG. 13) to include a fewer number of days left to respond to the request. Alternatively, or in addition, the system may use other techniques to convey to a respondent that the request should be expedited (e.g., change the color of the request, send a message to the respondent that they should process the request before non-prioritized requests, etc.)

In various embodiments, in response to the system determining that the priority of a particular DSAR should be lowered, the system may automatically adjust the deadline for responding to the DSAR by adding to the number of days left to respond to the request.

### Automatic Deletion of Data Subject Records Based on Detected Systems

In particular embodiments, in response a data subject submitting a request to delete their personal data from an organization's systems, the system may: (1) automatically determine where the data subject's personal data is stored; and (2) in response to determining the location of the data (which may be on multiple computing systems), automatically facilitate the deletion of the data subject's personal data from the various systems (e.g., by automatically assigning a plurality of tasks to delete data across multiple business systems to effectively delete the data subject's personal data from the systems). In particular embodiments, the step of facilitating the deletion may comprise, for example: (1) overwriting the data in memory; (2) marking the data for overwrite; (2) marking the data as free (e.g., and deleting a directory entry associated with the data); and/or (3) any other suitable technique for deleting the personal data. In particular embodiments, as part of this process, the system uses an appropriate data model (see discussion above) to efficiently determine where all of the data subject's personal data is stored.

Automatic Determination of Business Processes that Increase Chance of Deletion Requests

In various embodiments, the system is adapted to store, in memory, a log of DSAR actions. The system may also store, in memory, additional information regarding the data subjects of each of the requests. The system may use this information, for example, to determine which business processes are most commonly associated with a data subject submitting a request to have their personal information deleted from the organization's systems. The organization may then use this information to revise the identified business processes in an effort to reduce the number of deletion requests issued by data subjects associated with the business processes.

As a particular example, the system may analyze stored information to determine that a high number (e.g., 15%) of all participants in a company's loyalty program submit requests to have their personal information deleted from the company's systems. In response to making this determination, the system may issue an electronic alert to an appropriate individual (e.g., a privacy officer of the company), informing them of the high rate of members of the company's loyalty program issuing personal data delete requests. This alert may prompt the individual to research the issue and try to resolve it.

### Automated Data Subject Verification

As may be understood in light of this disclosure, a particular organization may undertake a plurality of different privacy campaigns, processing activities, etc. that involve the collection and storage of personal data. In various embodiments, an organization, corporation, etc. may be required to provide information requested by an individual for whom the organization stores personal data. As a particular example, an organization may be required to provide an individual with a listing of, for example: (1) any personal data that the organization is processing for an individual, (2) an explanation of the categories of data being processed and the purpose of such processing; (3) categories of third parties to whom the data may be disclosed; (4) etc. In particular embodiments, when processing a data subject access request (DSAR) or other consumer rights request (e.g., a request for such information), a data subject access request fulfillment system 100 may be configured to verify an identity of the requestor (e.g., a data subject) prior to processing the request. It is noted that the terms data access request (DSAR) and consumer rights request may be used interchangeably throughout the disclosure to represent a request submitted to an organization with respect to personal data involving a data subject and the use of one or the other should be not be viewed as limiting the scope of the disclosure or that embodiments of the disclosure are limited to particular types of requests.

In various embodiments, a data subject access request fulfillment system 100 may be implemented in the context of any suitable privacy management system that is configured to ensure compliance with one or more legal or industry standards related to the collection and/or storage of private information (e.g., such as personal data). In various embodiments, a particular organization, sub-group, or other entity may initiate a privacy campaign or other activity (e.g., processing activity) as part of its business activities. In such embodiments, the privacy campaign may include any undertaking by a particular organization (e.g., such as a project or other activity) that includes the collection, entry, and/or storage (e.g., in computer memory) of any personal data associated with one or more individuals (e.g., data subjects). In particular embodiments, a privacy campaign may include any project undertaken by an organization that includes the use of personal data, or any other activity that could have an impact on the privacy of one or more individuals.

In any embodiment described herein, personal data may include, for example: (1) the name of a particular data subject (which may be a particular individual); (2) the data subject's address; (3) the data subject's telephone number; (4) the data subject's e-mail address; (5) the data subject's social security number; (6) information associated with one or more of the data subject's credit accounts (e.g., credit card numbers); (7) banking information for the data subject; (8) location data for the data subject (e.g., their present or past location); (9) internet search history for the data subject; and/or (10) any other suitable personal information, such as other personal information discussed herein or other suitable personally identifiable information. In particular embodiments, such personal data may include one or more cookies (e.g., where the individual is directly identifiable or may be identifiable based at least in part on information stored in the one or more cookies).

Various privacy and security policies (e.g., such as the European Union's General Data Protection Regulation, California's California Consumer Privacy Act, and other such policies) may provide data subjects (e.g., individuals, organizations, consumers, or other individuals and/or entities) with certain rights related to the data subject's personal data that is collected, stored, or otherwise processed by an organization. These rights may include, for example: (1) a right to obtain confirmation of whether a particular organization is processing their personal data; (2) a right to obtain information about the purpose of the processing (e.g., one or more reasons for which the personal data was collected); (3) a right to obtain information about one or more categories of data being processed (e.g., what type of personal data is being collected, stored, etc.); (4) a right to obtain information about one or more categories of recipients with whom their personal data may be shared (e.g., both internally within the organization or externally); (5) a right to obtain information about a time period for which their personal data will be stored (e.g., or one or more criteria used to determine that time period); (6) a right to obtain a copy of any personal data being processed (e.g., a right to receive a copy of their personal data in a commonly used, machine-readable format); (7) a right to request erasure (e.g., the right to be forgotten), rectification (e.g., correction or deletion of inaccurate data), or restriction of processing of their personal data; and (8) any other suitable rights related to the collection, storage, and/or processing of their personal data (e.g., which may be provided by law, policy, industry or organizational practice, etc.).

In particular embodiments, when processing a DSAR, a data subject access request fulfillment system 100 may be configured to verify an identity of the data subject prior to processing the request (e.g., or as part of the processing step). In various embodiments, confirming the identity of the data subject may, for example, limit a risk that a third-party or other entity may gain unlawful or unconsented access to the requestor's personal data. The system may, for example, limit processing and/or fulfilling requests relating to a particular data subject to requests that are originated by (e.g., received from) the particular data subject. When processing a DSAR, the system may be configured to use all reasonable measures to verify the identity of the data subject who requests access (e.g., in particular in the context of online services and online identifiers). In particular embodiments, the system is configured to substantially automatically verify an identity of a data subject when processing the DSAR.

In particular embodiments, the system may be configured to dynamically determine an identity verification technique required prior to fulfilling a DSAR, and substantially automatically implement the determined technique prior to fulfilling the request. As may be understood in light of this disclosure, a level of identity verification required to process and/or fulfil a particular DSAR (e.g., consumer rights request or other request related to information stored, collected, processed, etc. by an organization as discussed herein) may vary based on one or more factors. These factors may include, for example, one or more of the following: (1) the type of processing to be carried out for the request; (2) one or more particular laws applicable to the collection, processing, and/or storage of the personal data (e.g., applicable to the request); (3) a residency of the data subject or other individual making the request; (4) a location of the data subject or other individual making the request; (5) an age of the data subject or other individual making the request; and/or (6) any other suitable factor related to the request; one or more laws, rules or regulations that apply to the request or any data that is the subject of the request; the data subjected themselves; a location of the data subject or the entity that is receiving the request; and/or any other suitable factor.

In various embodiments, before a DSAR can be processed, the data subject's identity may need to be verified. In various embodiments, the system provides a mechanism to automatically detect the type of authentication (level of identity verification) required for a particular DSAR based on factors such as the type of DSAR being made, laws applicable to the request, relocation of the requestor, other applicable factors, and/or combination thereof and automatically implement the type of authentication required to fulfil the DSAR. For example, in particular embodiments, the system may implement the type of authentication required to fulfil the DSAR by generating and/or configuring a graphical user interface (e.g., webpage) that prompts the requestor to provide identity information to verify their identity against that type of authentication. For example, a subject rights request might only require two types of authentication, but a deletion request may require four types of authentication to verify the identity of the requestor. Therefore, the system may automatically detect which type of authentication (level of identity verification) is required based on the DSAR and/or other factors and generate and/or configure an appropriate graphical user interface to request the required identity information from the requestor to verify their identity.

Stated more particularly, when processing a DSAR, the system may be configured to verify an identity of the requester as the data subject prior to processing the request (e.g., or as part of the processing step). In various embodiments, confirming the identity of the requester as the data subject can limit a risk that an unauthorized third-party or other entity may gain unlawful or unconsented access to the data subject's personal data. Accordingly, in particular embodiments, the system may limit processing and/or fulfilling requests related to a particular data subject to requests that are originated by (e.g., received from) the particular data subject. Therefore, when processing a DSAR, the system may be configured to use various reasonable measures to verify the identity of the requestor who has submitted the request to access a data subject's personal data (e.g., in particular in the context of online services and online identifiers) as the applicable data subject.

For example, in particular embodiments, the system may be configured to substantially automatically authenticate and/or verify an identity of a requestor using one or more suitable verification techniques. These suitable verification techniques may include, for example: (1) one or more credit-based and/or public or private information-based verification techniques; (2) one or more company verification techniques (e.g., in the case of a business-to-business DSAR); (3) one or more techniques involving integration with a company's employee authentication system; (4) one or more techniques involving a company's (e.g., organization's) consumer portal authentication process; (5) etc. Various exemplary techniques for authenticating a data subject are discussed more fully below.

In particular embodiments, when authenticating a data subject (e.g., validating the data subject's identity), the system may be configured to execute particular identity confirmation steps, for example, by interfacing with one or more external systems (e.g., one or more third-party data aggregation systems). For example, the system, when verifying a data subject's identity, may begin by verifying that a person with the data subject's name, address, social security number, or other identifying characteristic (e.g., which may have been provided by the data subject as part of the data subject access request) actually exists. In various embodiments, the system is configured to interface with (e.g., transmit a search request to) one or more credit reporting agencies (e.g., Experian, Equifax, TransUnion, etc.) to confirm that a person with one or more characteristics provided by the data subject exists. The system may, for example, interface with such credit reporting agencies via a suitable plugin (e.g., software plugin). Additionally, there might be a verification on behalf of a trusted third-party system (e.g., the controller).

In still other embodiments, the system may be configured to utilize one or more other third-party systems (e.g., such as LexisNexis, IDology, RSA, etc.), which may, for example, compile utility and phone bill data, property deeds, rental agreement data, and/or other public records for various individuals. The system may be configured to interface with one or more such third-party systems to confirm that a person with one or more characteristics provided by the data subject exists.

After the step of confirming the existence of a person with the one or more characteristics provided by the data subject, the system may be configured to confirm that the person making the data subject access request is, in fact, the data subject. The system may, for example, verify that the requestor is the data subject by prompting the requestor to answer one or more knowledge-based authentication questions (e.g., out-of-wallet questions). In particular embodiments, the system is configured to utilize one or more third-party services as a source of such questions (e.g., any of the suitable third-party sources discussed immediately above). The system may use third-party data from the one or more third-party sources to generate one or more questions. These one or more questions may include questions that a data subject should know an answer to without knowing the question ahead of time (e.g., one or more previous addresses, a parent or spouse name and/or maiden name, etc.).

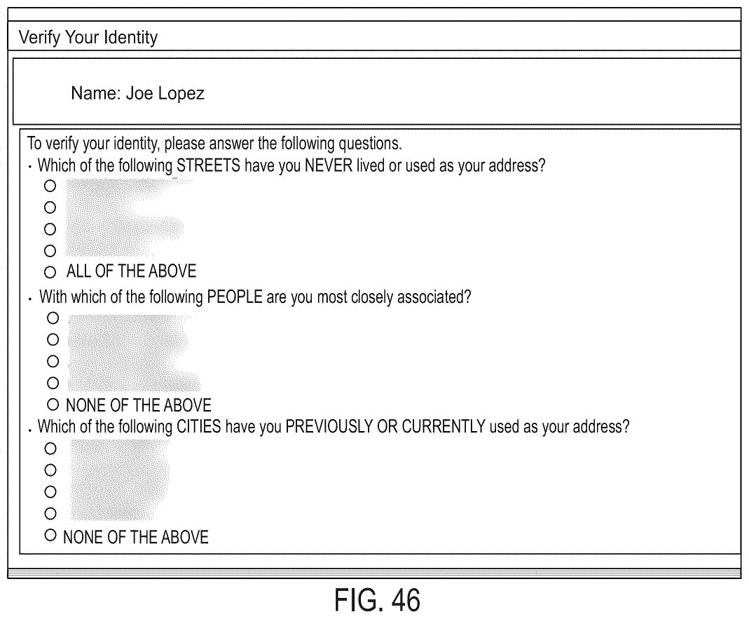

FIG. 46 depicts an exemplary identity verification questionnaire. As may be understood from this figure, an identity verification questionnaire may include one or more questions whose responses include data that the system may derive from one or more credit agencies or other third-party data aggregation services (e.g., such as previous street addresses, close associates, previous cities lived in, etc.). In particular embodiments, the system is configured to provide these one or more questions to the requestor in response to receiving the DSAR. In other embodiments, the system is configured to prompt the requestor to provide responses to the one or more questions at a later time (e.g., during processing of the request). In other embodiments, the system is configured to substantially automatically compare one or more pieces of information provided as part of the DSAR to one or more pieces of data received from a third-party data aggregation service in order to substantially automatically verify the requestor's identity.

In still other embodiments, the system may be configured to prompt a requestor to provide one or more additional pieces of identity information in order to verifies the requestor's identity. This information may include, for example: (1) at least a portion of the requestor's social security number (e.g., last four digits); (2) a name and/or place of birth of the requestor's father; (3) a name, maiden name, and/or place of birth of the requestor's mother; and/or (4) any other information which may be useful for confirming the requestor's identity (e.g., such as information available on the requestor's birth certificate). In other embodiments, the system may be configured to prompt the requestor to provide authorization for the company to check the requestor's social security or other private records (e.g., credit check authorization, etc.) to obtain information that the system may use to confirm the requestor's identity. In other embodiments, the system may prompt the requestor to provide one or more images (e.g., using a suitable mobile computing device) of an identifying document (e.g., a birth certificate, social security card, driver's license, etc.).

The system may, in response to the requestor providing one or more responses that match information the system has received from one or more third-party data aggregators or through any other suitable background, credit, or other search, substantially automatically authenticate the requestor as the data subject. The system may then continue processing the data subject's request, and ultimately fulfill their request.

In particular embodiments, such as embodiments in which the requestor includes a business (e.g., as in a business to business DSAR), the system may be configured to authenticate the requesting business using one or more company verification techniques. These one or more company validation techniques may include, for example, validating a vendor contract (e.g., between the requesting business and the company receiving the DSAR); receiving a matching token, code, or other unique identifier provided by the company receiving the DSAR to the requesting business; receiving a matching file in possession of both the requesting business and the company receiving the DSAR; receiving a signed contract, certificate (e.g., digital or physical), or other document memorializing an association between the requesting business and the company receiving the DSAR; and/or any other suitable method of validating that a particular request is actually made on behalf of the requesting business (e.g., by requesting the requesting business to provide one or more pieces of information, one or more files, one or more documents, etc. that may only be accessible to the requesting business).

In other embodiments, the system may be configured to authenticate a requestor via integration with a company's employee or customer (e.g., consumer) authentication process. For example, in response to receiving a DSAR that indicates that the data subject is an employee of the company receiving the DSAR, the system may be configured to prompt the requestor to login to the company's employee authentication system (e.g., Okta, Azure, AD, etc.) In this way, the system may be configured to authenticate the requestor based at least in part on the requestor successfully logging into the authentication system using the data subject's credentials. Similarly, in response to receiving a DSAR that indicates that the data subject is a customer of the company receiving the DSAR, the system may be configured to prompt the customer to login to an account associated with the company (e.g., via a consumer portal authentication process). For example, this may include an Apple ID for DSARs received by Apple. In this way, the system may be configured to authenticate the requestor based at least in part on the requestor successfully logging into the authentication system using the data subject's credentials. In some embodiments, the system may be configured to require the requestor to login using two-factor authentication or other suitable existing employee or consumer authentication process.

The system may be further adapted to facilitate processing of DSARs that are received via the webforms, or any other suitable mechanism. For example, the data subject access request fulfillment system 100 may be adapted to execute one or more of the following steps for each particular DSAR received via the webforms (or other suitable mechanism) described above: (1) before processing the DSAR, confirm that the DSAR was actually submitted by the particular data subject of the DSAR (or, for example, by an individual authorized to make the DSAR on the data subject's behalf, such as a parent, guardian, power-of-attorney holder, etc.)—any suitable method may be used to verify the identity of the entity/individual submitting the DSAR—for example, if the system receives the DSAR via a third-party computer system, the system may perform verification via API secret, or by requiring a copy of one or more particular legal documents (e.g., a particular contract between two particular entities)—the system may verify the identity of an individual by, for example, requiring the individual (e.g., data subject) to provide particular account credentials, by requiring the individual to provide particular out-of-wallet information, through biometric scanning of the individual (e.g., finger or retinal scan), or via any other suitable identity verification technique; (2) if the DSAR was not submitted by the particular data subject, deny the request; (3) if the DSAR was submitted by the particular data subject, advance the processing of the DSAR; (4) route the DSAR to the correct individual(s) or groups internally for handling; (5) facilitate the assignment of the DSAR to one or more other individuals for handling of one or more portions of the DSAR; (6) facilitate the suspension of processing of the data subject's data by the organization; and/or (7) change the policy according to which the data subject's personal data is retained and/or processed by the system. In particular embodiments, the system may perform any one or more of the above steps automatically. The system then generates a receipt for the DSAR that the user can use as a transactional record of their submitted request.

In particular embodiments, when processing a DSAR, the data subject access request fulfillment system 100 may for example, be configured to perform one or more of the following steps: (1) receiving the DSAR via a computing device, where the DSAR is a request for a particular organization to perform one or more actions with regard to one or more pieces of personal data associated with a data subject that the particular organization has obtained on the data subject; (2) in response to receiving the DSAR, determining a location of the computing device; (3) based at least part on the location, determining a level of identity verification required from the requestor in order to process the DSAR, where the level of identity verification required from the requestor dictates at least one minimum type of identity verification that must be provided; (4) dynamically providing a prompt for display on the computing device for the requestor to provide the at least one minimum type of identity verification; (5) receiving the at least one minimum type of identity verification; (6) using the at least one minimum type of identity verification to verify the requestor's (e.g., the data subject's) identity; and (7) in response to verifying the requestor's identity, processing the DSAR.

Yet, in particular embodiments, when processing a DSAR, the data subject access request fulfillment system 100 may be configured to perform one or more of the following steps: (1) receiving the DSAR via a computing device, where the DSAR is a request for a particular organization to perform one or more actions with regard to one or more pieces of personal data associated with a data subject that the particular organization has obtained on the data subject; (2) in response to receiving the DSAR, determining a location of the computing device; (3) based at least part on the location, determining a level of identity verification required from the requestor (e.g., the data subject) in order to process the DSAR, wherein the level of identity verification required from the requestor dictates at least one minimum type of identity verification the requestor must provide; (4) based at least in part on the level of identity verification, dynamically generating or configuring a graphical user interface for display on the computing device, wherein the graphical user interface is configured with one or more input elements such as identity verification prompts to prompt the requestor to provide input for the at least one minimum type of identity verification; (5) receiving the input for the at least one minimum type of identity verification; (6) using the input for the at least one minimum type of identity verification to verify the requestor's identity; and (7) in response to verifying the identity of the requestor, processing the DSAR.

Still yet, in particular embodiments, when processing a DSAR, the data subject access request fulfillment system 100 may be configured to perform one or more of the following steps: (1) receiving, via a browser application executed on a user (computing) device, a DSAR for a data subject, wherein the DSAR is for performing an action with regard to personal data associated with the data subject; (2) detecting a state of the browser application indicating a location of the user device; (3) identifying a law that applies to the DSAR based on the location; (4) determining a level of identity verification required based on the law; (5) generating, based on the level of identity verification, a graphical user interface for the browser application by configuring a first identity verification prompt on the graphical user interface and excluding a second identity verification prompt from the graphical user interface, wherein: the first identity verification prompt is configured for receiving input for a first type of identity verification, and the second identity verification prompt is configured for receiving input for a second type of identity verification; (6) transmitting a first instruction to the user device to present the graphical user interface on the user device; (7) receiving the input for the first type of identity verification via the first identity verification prompt; (8) verifying an identity of the data subject based on the input for the first type of identity verification; and (9) responsive to verifying the identity of the data subject, causing performance of the action with regard to the personal data associated with the data subject.

Still yet, in particular embodiments, when processing a DSAR, the data subject access request fulfillment system 100 may be configured to perform one or more of the following steps: (1) identifying a law that applies to a DSAR for a data subject based on a location of a computing device submitting the DSAR, wherein the DSAR is for performing an action with regard to personal data associated with the data subject; (2) determining a first acceptable type of identity verification and a second acceptable type of identity verification required to verify an identity of the data subject based on the law; (3) generating a graphical user interface by configuring a first input element on the graphical user interface and excluding a second input element from the graphical user interface, wherein: the first input element is configured for receiving input for the first acceptable type of identity verification, and the second input element is configured for receiving input for the second acceptable type of identity verification; (4) providing the graphical user interface to the computing device; (5) receiving, via the first input element, the input for the first acceptable type of identity verification; and (6) responsive to receiving the input for the first acceptable type of identity verification: verifying the identity of the data subject based on the input for the first acceptable type of identity verification; and (7) responsive to verifying the identity of the data subject, having the action performed with regard to the personal data associated with the data subject.

Still yet, in particular embodiments, when processing a DSAR, data subject access request fulfillment system 100 may be configured to perform one or more of the following steps: (1) determining a minimum type of identity verification required to be provided for a data subject from a plurality of types of identity verification based on a law, wherein the law applies to a DSAR received for the data subject and is based on a location of a computing device submitting the DSAR; (2) dynamically generating a prompt requesting input for the minimum type of identity verification and causing the computing device to display the prompt; (3) receiving the input for the minimum type of identity verification; (4) verifying an identity of the data subject based on the input for the minimum type of identity verification; and (5) responsive to verifying the identity of the data subject, having an action performed with regard to personal data associated with the data subject.

In particular embodiments, the system may be configured to dynamically identify a level of identity verification required based at least in part on a geographic location of the user (e.g., the requestor) submitting the DSAR (e.g., or the device from which the user made the request), one or more appropriate laws and/or regulations that apply to the request or type of request, and/or other appropriate factors associated with the request. For example, the system may be configured to determine a level of identity verification required for a user to submit a request based on the user's physical location (e.g., in a particular state) and/or one or more laws that apply to the location (e.g., one or more laws that exist in the particular state). The system may then be configured to determine, based on the type of request and/or one or more requirements that apply, a threshold (acceptable) type of identity verification required in order to complete and/or process the request (e.g., a threshold type of identity verification required by the one or more legal or industry requirements that apply). The system may then be configured to dynamically generate and/or configure a graphical user interface to display that includes one or more input elements prompting the user for one or more pieces of required identity information (e.g., on the user's computing device) in order to capture the required (e.g., threshold) identity information.

In various other embodiments, the system may be configured to display, to the user (e.g., on the computing device) an optimal choice of identity verification based at least on the type of request and the user. For example, in various embodiments, a certain request type may enable the system to verify the user's identity based on one or more different validation techniques. For example, in particular embodiments, the threshold identification requirement may alternatively require login credentials or name and phone number. In this example, the system may determine to request the login credentials as that requires less personal information to be submitted by the user (e.g., the system may require the login credentials in response to determining that the user is an account holder).

In various embodiments, the system is configured to determine which of a plurality of available identity verification requirements include submission, by the requestor (e.g., the data subject), of the fewest pieces of personal data (e.g., a minimum type of identity verification). For example, in response to receiving the DSAR (e.g., or other consumer rights request), the system may be configured to determine whether the requestor has an account with the organization to which the requestor has submitted the request. In response to determining that the requestor has a user account, the system may be configured to prompt the requestor to provide one or more login credentials in order to validate the user's identity.

In particular embodiments, the system may be configured to generate and/or configure a custom identity verification interface (e.g., graphical user interface) in response to receiving a DSAR based on any information discussed herein. For instance, in particular embodiments, the system may be configured to generate and/or configure a custom identity verification interface based at least in part on a level of identity verification required to process the DSAR. Here, the level of identity verification may be determined based at least in part on one or more parameters and/or factors associated with the request such as, for example, the type of request received, the laws applicable to the request, the location of the user (e.g., location of a user device), and/or any combination thereof.

For example, the system may determine the level of identity verification required to process the request based at least in part on a law applicable to the request, as identified based at least in part on a location of a computing device being used by the user (user device). The system may use detected data for the computing device to identify the location such as, for example, a state of a browser application executing on the computing device indicating a location of the computing device. Accordingly, the system may configure the custom identity verification interface to include one or more input elements based at least in part on the level of identity verification so that the user may enter required identity information needed to verify the user's identity. For example, the one or more input elements may be identity verification prompts configured to prompt the user for the required identity information. The system may then provide the custom interface to display (e.g., transmits an instruction to have the custom interface displayed) to the user in order to collect the required identity information for verifying the user's identity prior to processing the DSAR.

In particular embodiments, a Data Subject Identity Validation Module 5000 is configured to receive a DSAR, validate/verify the identity of a data subject for the DSAR, process the request, and fulfill the request based at least in part on one or more request parameters. In various embodiments, an organization, corporation, etc. may be required to provide information requested by an individual for whom the organization stores personal data within a certain time period (e.g., 30 days). As a particular example, an organization may be required to provide an individual with a listing of, for example: (1) any personal data that the organization is processing for an individual, (2) an explanation of the categories of data being processed and the purpose of such processing; and (3) categories of third parties to whom the data may be disclosed. In particular embodiments, when processing a DSAR, the system may be configured to verify an identity of the data subject prior to processing the request (e.g., or as part of the processing step).

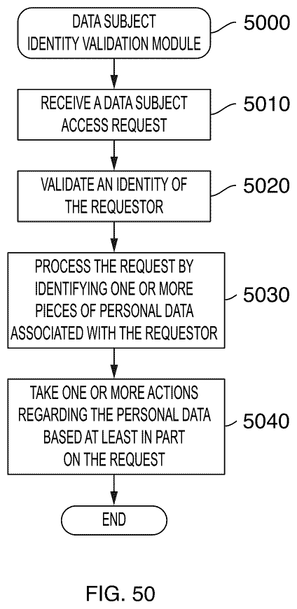

Turning to FIG. 50, when executing the Data Subject Identity Validation Module 5000, the system begins, at Step S010, by receiving a DSAR. In various embodiments, the system receives the request via a suitable web form. In certain embodiments, the request comprises a particular request to perform one or more actions with any personal data stored by a particular organization regarding a corresponding data subject. For example, in some embodiments, the request may include a request to view one or more pieces of personal data stored by the system regarding the data subject. In other embodiments, the request may include a request to delete one or more pieces of personal data stored by the system regarding the data subject. In still other embodiments, the request may include a request to update one or more pieces of personal data stored by the system regarding the data subject.

Continuing to Step S020, the system is configured to validate (verify) an identity of the requestor prior to processing the request (e.g., or as part of the processing step). In various embodiments, confirming the identity of the requestor prior to processing the request can limit a risk that an unauthorized third-party or other entity may gain unlawful or unconsented access to a data subject's personal data. The system may, for example, limit processing and fulfilling requests relating to a particular data subject to requests that are originated by (e.g., received from) the particular data subject. When processing a DSAR, the system may be configured to use all reasonable measures to verify the identity of the requestor who has submitted the DSAR (e.g., in particular in the context of online services and online identifiers). In particular embodiments, the system is configured to substantially automatically verify an identity of a data subject when processing the DSAR. In various embodiments, the system provides a mechanism to automatically detect the type of authentication (e.g., level of verification) required for a particular data subject (e.g., requestor) based on the type of DSAR being made and automatically issues a request to the data subject to verify their identity against that type of authentication. For example, a subject rights request might only require two identity verification methods, but a deletion request may require four identity verification methods. The system may automatically detect the number of identity verification methods required based on the DSAR and send an appropriate request to the data subject to verify their identity.

In particular embodiments, the system may be configured to substantially automatically (e.g., automatically) authenticate, verify, and/or validate an identity of a data subject using any suitable technique. These techniques may include, for example: (1) one or more credit-based and/or public or private information-based verification techniques; (2) one or more company verification techniques (e.g., in the case of a business-to-business DSAR); (3) one or more techniques involving integration with a company's employee authentication system; (4) one or more techniques involving a company's (e.g., organization's) consumer portal authentication process; (5) etc. Various exemplary techniques for authenticating a requestor are discussed more fully below.

In particular embodiments, when authenticating a data subject (e.g., verifying a requestor's identity as a data subject), the system may be configured to execute particular identity confirmation steps, for example, by interfacing with one or more external systems (e.g., one or more third-party data aggregation systems). For example, the system, when authenticating a data subject, may begin by verifying that a person with the data subject's name, address, social security number, or other identifying characteristic (e.g., which may have been provided by the data subject as part of the DSAR) actually exists. In various embodiments, the system is configured to interface with (e.g., transmit a search request to) one or more credit reporting agencies (e.g., Experian, Equifax, TransUnion, etc.) to confirm that a person with one or more characteristics provided by the data subject (e.g., requestor) exists. The system may, for example, interface with such credit reporting agencies via a suitable plugin (e.g., software plugin). Additionally, there might be a verification on behalf of a trusted third-party system (e.g., the controller).

In still other embodiments, the system may be configured to utilize one or more other third-party systems (e.g., such as LexisNexis, IDology, RSA, etc.), which may, for example, compile utility and phone bill data, property deeds, rental agreement data, and other public records for various individuals. The system may be configured to interface with one or more such third-party systems to confirm that a person with one or more characteristics provided by the data subject (e.g., requestor) exists. After confirming the existence of a person with the one or more characteristics provided by the data subject, the system may be configured to confirm that the person making the DSAR is, in fact, the data subject.

In some embodiments, the system may be configured to prompt a requestor to provide one or more additional pieces of information in order to verify the requestor's identity. The system may, for example, verify that the requestor is the data subject by prompting the requestor to answer one or more knowledge-based authentication questions (e.g., out-of-wallet questions). In particular embodiments, the system is configured to utilize one or more third-party services as a source of such questions (e.g., any of the suitable third-party sources discussed immediately above). The additional information called for by the prompt to the requester may include, for example: (1) at least a portion of the requestor's social security number (e.g., last four digits); (2) a name and/or place of birth of the requestor's father; (3) a name, maiden name, and/or place of birth of the requestor's mother; and/or (4) any other information which may be useful for confirming the requestor's identity (e.g., such as information available on the requestor's birth certificate or questions that a data subject should know an answer to without knowing the question ahead of time). In some implementations, there may be a threshold number of questions the requestor must answer correctly or a threshold number of additional pieces of information the requestor must provide to validate the identity of the requestor.

In other embodiments, the system may prompt the requestor to provide additional information in the form of one or more images (e.g., using a suitable mobile computing device), such as an image of an identifying document (e.g., a birth certificate, social security card, driver's license, etc.). The image of the additional information may be provided by the requestor to the system via a secure terminal or secure link to prevent interception of the image or unwarranted access to the additional information. Additionally, the image of the additional information may be encrypted for the transmission of the image.

In some embodiments, the system may be configured to prompt the requestor to provide authorization for the company to check the requestor's social security or other private records (e.g., credit check authorization, etc.) to obtain information that the system may use to confirm the requestor's identity. The system may, in response to the requestor providing one or more responses that match information that the system receives from one or more third-party data aggregators or through any other suitable background, credit, or other search, substantially automatically (e.g., automatically) authenticate the requestor as the data subject. The system may then continue processing the requestor's request, and ultimately fulfill their request.

In particular embodiments, such as embodiments in which the requestor includes a business (e.g., as in a business to business DSAR), the system may be configured to authenticate the requesting business using one or more company validation techniques. These one or more company validation techniques may include, for example, validating a vendor contract (e.g., between the requesting business and the company receiving the DSAR); receiving a matching token, code, or other unique identifier provided by the company receiving the DSAR to the requesting business; receiving a matching file in possession of both the requesting business and the company receiving the DSAR; receiving a signed contract, certificate (e.g., digital or physical), or other document memorializing an association between the requesting business and the company receiving the DSAR; and/or any other suitable method of validating that a particular request is actually made on behalf of the requesting business (e.g., by requesting the requesting business to provide one or more pieces of information, one or more files, one or more documents, etc. that may only be accessible to the requesting business). In such implementations, when the requestor provides information to the system as a part of the company validation technique, the data identifying the information to the system may be provided by the requestor to the system via a secure terminal or secure link. Additionally, the data identifying the information as a part of the company validation technique may be encrypted for the transmission of the data.

In other embodiments, the system may be configured to authenticate a request via integration with a company's employee or customer (e.g., consumer) authentication process. For example, in response to receiving a DSAR that indicates that the associated data subject is an employee of the company receiving the DSAR, the system may be configured to prompt the requestor to login to the company's employee authentication system (e.g., Okta, Azure, AD, etc.) In this way, the system may be configured to authenticate the requestor based at least in part on the requestor successfully logging into the authentication system using the data subject's credentials. Similarly, in response to receiving a DSAR that indicates that the data subject is a customer of the company receiving the DSAR, the system may be configured to prompt the customer to login to an account associated with the company (e.g., via a consumer portal authentication process). In a particular example, this may include an Apple ID for DSARs received by Apple. In this way, the system may be configured to authenticate the requestor based at least in part on the requestor successfully logging into the authentication system using the data subject's credentials. In some embodiments, the system may be configured to require the requestor to login using two-factor authentication or other suitable existing employee or consumer authentication process.

In particular embodiments, when processing a DSAR, the data subject access request fulfillment system 100 may for example, be configured to perform one or more of the following steps: (1) receiving the DSAR via a computing device, where the DSAR is a request for a particular organization to perform one or more actions with regard to one or more pieces of personal data associated with a data subject that the particular organization has obtained on the data subject; (2) in response to receiving the DSAR, determining a location of the computing device; (3) based at least part on the location, determining a level of identity verification required from the requestor in order to process the DSAR, where the level of identity verification required from the requestor dictates at least one minimum type of identity verification that must be provided; (4) dynamically providing a prompt for display on the computing device for the requestor to provide the at least one minimum type of identity verification; (5) receiving the at least one minimum type of identity verification; (6) using the at least one minimum type of identity verification to verify the requestor's (e.g., the data subject's) identity; and (7) in response to verifying the requestor's identity, processing the DSAR.

Yet, in particular embodiments, when processing a DSAR, the data subject access request fulfillment system 100 may be configured to perform one or more of the following steps: (1) receiving the DSAR via a computing device, where the DSAR is a request for a particular organization to perform one or more actions with regard to one or more pieces of personal data associated with a data subject that the particular organization has obtained on the data subject; (2) in response to receiving the DSAR, determining a location of the computing device; (3) based at least part on the location, determining a level of identity verification required from the requestor (e.g., the data subject) in order to process the DSAR, wherein the level of identity verification required from the requestor dictates at least one minimum type of identity verification the requestor must provide; (4) based at least in part on the level of identity verification, dynamically generating or configuring a graphical user interface for display on the computing device, wherein the graphical user interface is configured with one or more input elements such as identity verification prompts to prompt the requestor to provide input for the at least one minimum type of identity verification; (5) receiving the input for the at least one minimum type of identity verification; (6) using the input for the at least one minimum type of identity verification to verify the requestor's identity; and (7) in response to verifying the identity of the requestor, processing the DSAR.

Yet, in particular embodiments, when processing a DSAR, the data subject access request fulfillment system 100 may be configured to perform one or more of the following steps: (1) receiving via a browser application executed on a user (computing) device, a DSAR for a data subject, wherein the DSAR is for performing an action with regard to personal data associated with the data subject; (2) detecting a state of the browser application indicating a location of the user device; (3) identifying a law that applies to the DSAR based on the location; (4) determining a level of identity verification required based on the law; (5) generating, based on the level of identity verification, a graphical user interface for the browser application by configuring a first identity verification prompt on the graphical user interface and excluding a second identity verification prompt from the graphical user interface, wherein: the first identity verification prompt is configured for receiving input for a first type of identity verification, and the second identity verification prompt is configured for receiving input for a second type of identity verification; (6) transmitting a first instruction to the user device to present the graphical user interface on the user device; (7) receiving the input for the first type of identity verification via the first identity verification prompt; (8) verifying an identity of the data subject based on the input for the first type of identity verification; and (9) responsive to verifying the identity of the data subject, causing performance of the action with regard to the personal data associated with the data subject.

Still yet, in particular embodiments, when processing a DSAR, the data subject access request fulfillment system 100 may be configured to perform one or more of the following steps: (1) identifying a law that applies to a DSAR for a data subject based on a location of a computing device submitting the DSAR, wherein the DSAR is for performing an action with regard to personal data associated with the data subject; (2) determining a first acceptable type of identity verification and a second acceptable type of identity verification required to verify an identity of the data subject based on the law; (3) generating a graphical user interface by configuring a first input element on the graphical user interface and excluding a second input element from the graphical user interface, wherein: the first input element is configured for receiving input for the first acceptable type of identity verification, and the second input element is configured for receiving input for the second acceptable type of identity verification; (4) providing the graphical user interface to the computing device; (5) receiving, via the first input element, the input for the first acceptable type of identity verification; and (6) responsive to receiving the input for the first acceptable type of identity verification: verifying the identity of the data subject based on the input for the first acceptable type of identity verification; and responsive to verifying the identity of the data subject, having the action performed with regard to the personal data associated with the data subject.

Still yet, in particular embodiments, when processing a DSAR, data subject access request fulfillment system 100 may be configured to perform one or more of the following steps: (1) determining a minimum type of identity verification required to be provided for a data subject from a plurality of types of identity verification based on a law, wherein the law applies to a DSAR received for the data subject and is based on a location of a computing device submitting the DSAR; (2) dynamically generating a prompt requesting input for the minimum type of identity verification and causing the computing device to display the prompt; (3) receiving the input for the minimum type of identity verification; (4) verifying an identity of the data subject based on the input for the minimum type of identity verification; and (5) responsive to verifying the identity of the data subject, having an action performed with regard to personal data associated with the data subject.

In particular embodiments, the system may be configured to dynamically identify a level of identity verification required based at least in part on a geographic location of the user (e.g., the requestor) submitting the DSAR (e.g., or the device from which the user made the request), one or more appropriate laws and/or regulations that apply to the request or type of request, and/or other appropriate factors associated with the request. For example, the system may be configured to determine a level of identity verification required for a user to submit a request based on the user's physical location (e.g., in a particular state) and/or one or more laws that apply to the location (e.g., one or more laws that exist in the particular state). The system may then be configured to determine, based on the type of request and one or more requirements that apply, a threshold identity verification required (e.g., an acceptable type of identity verification) in order to complete and/or process the request (e.g., a threshold identity verification required by the one or more legal or industry requirements that apply). The system may then be configured to dynamically generate and/or configure a graphical user interface to display that includes one or more input elements prompting the user for one or more pieces of needed identity information (e.g., on the user's computing device) in order to capture the required (e.g., threshold) identity information.

In various other embodiments, the system may be configured to display, to the user (e.g., on the computing device) an optimal choice of identity verification based at least on the type of request and the user. For example, in various embodiments, a certain request type may enable the system to verify the user's identity based on one or more different validation techniques. For example, in particular embodiments, the threshold identification requirement may alternatively require login credentials or name and phone number. In this example, the system may determine to request the login credentials as that requires less personal information to be submitted by the user (e.g., the system may require the login credentials in response to determining that the user is an account holder).

In various embodiments, the system is configured to determine which of a plurality of available identity verification requirements include submission, by the requestor (e.g., the data subject), of the fewest pieces of personal data (e.g., minimum type of identity verification). For example, in response to receiving the DSAR (e.g., or other consumer rights request), the system may be configured to determine whether the requestor has an account with the organization to which the requestor has submitted the request. In response to determining that the requestor has a user account, the system may be configured to prompt the requestor to provide one or more login credentials in order to validate the user's identity.

In particular embodiments, the system may be configured to generate and/or configure a custom identity verification interface (e.g., graphical user interface) in response to receiving a DSAR based on any information discussed herein. For instance, in particular embodiments, the system may be configured to generate and/or configure a customer identity verification interface based at least in part on a level of identity verification required to process the DSAR. Here, the level of identity verification may be determined based at least in part on one or more parameters and/or factors associated with the request such as, for example, the type of request received, the laws applicable to the request, the location of the user (e.g., location of a user device), and/or any combination thereof.

For example, the system may determine the level of identity verification required to process the request based at least in part on a law applicable to the request, as identified based at least in part on a location of a computing device being used by the user (user device). The system may use detected data for the computing device to identify the location such as, for example, a state of a browser application executing on the computing device indicating a location of the computing device. Accordingly, the system may configure the custom identity verification interface to include one or more input elements based at least in part on the level of identity verification so that the user may enter required identity information needed to verify the user's identity. For example, the one or more input elements may be identity verification prompts configured to prompt the user for the required identity information. The system may then provide (e.g., transmits an instruction) the custom interface to display to the user in order to collect the required identity information for verifying the user's identity prior to process the DSAR.

Continuing to Step S030, the system is configured to process the request by identifying and retrieving one or more pieces of personal data associated with the data subject that are being processed by the system. For example, in various embodiments, the system is configured to identify any personal data stored in any database, server, or other data repository associated with a particular organization. In various embodiments, the system is configured to use one or more data models, such as those described above, to identify this personal data and suitable related information (e.g., where the personal data is stored, who has access to the personal data, etc.). In various embodiments, the system is configured to use intelligent identity scanning (e.g., as described above) to identify the data subject's personal data and related information that is to be used to fulfill the request.

In still other embodiments, the system is configured to use one or more machine learning techniques to identify such personal data. For example, the system may identify particular stored personal data based on, for example, a country in which a website that the DSAR was submitted is based, or any other suitable information.

Turning to Step S040, the system is configured to take one or more actions based at least in part on the request. In some embodiments, the system is configured to take one or more actions for which the request was submitted (e.g., display the personal data, delete the personal data, correct the personal data, etc.). In particular embodiments, the system is configured to take the one or more actions substantially automatically.

### Data Subject Blacklist

In various embodiments, a particular organization may not be required to respond to a data subject access request that originates (e.g., is received from) a malicious requestor. A malicious requestor may include, for example: (1) a requestor (e.g., an individual) that submits excessive or redundant data subject access requests; (2) a group of requestors such as researchers, professors, students, NGOs, etc. that submit a plurality of requests for reasons other than those reasons provided by policy, law, etc.; (3) a competitor of the company receiving the data subject access request that is submitting such requests to tie up the company's resources unnecessarily; (4) a terrorist or other organization that may spam requests to disrupt the company's operation and response to valid requests; and/or (5) any other request that may fall outside the scope of valid requests made for reasons proscribed by public policy, company policy, or law. In particular embodiments, the system is configured to maintain a blacklist of such malicious requestors.

In particular embodiments, the system is configured to track a source of each data subject access request and analyze each source to identify sources from which: (1) the company receives a large volume of requests; (2) the company receives a large number of repeat requests; (3) etc. These sources may include, for example: (1) one or more particular IP addresses; (2) one or more particular domains; (3) one or more particular countries; (4) one or more particular institutions; (5) one or more particular geographic regions; (6) etc. In various embodiments, in response to analyzing the sources of the requests, the system may identify one or more sources that may be malicious (e.g., are submitting excessive requests).

In various embodiments, the system is configured to maintain a database of the identified one or more sources (e.g., in computer memory). In particular embodiments, the database may store a listing of identities, data sources, etc. that have been blacklisted (e.g., by the system). In particular embodiments, the system is configured to, in response to receiving a new data subject access request, cross reference the request with the blacklist to determine if the requestor is on the blacklist or is making the request from a blacklisted source. The system may then, in response to determining that the requestor or source is blacklisted, substantially automatically reject the request. In particular embodiments, the blacklist cross-referencing step may be part of the requestor authentication (e.g., verification) discussed above. In various embodiments, the system may be configured to analyze request data on a company by company basis to generate a blacklist. In other embodiments, the system may analyze global data (e.g., all data collected for a plurality of companies that utilize the data subject access request fulfillment system 100) to generate the blacklist.

In particular embodiments, the system may be configured to fulfill data subject access requests for the purpose of providing a data subject with information regarding what data the company collects and for what purpose, for example, so the data subject can ensure that the company is collecting data for lawful reasons. As such, the system may be configured to identify requestors and other sources of data requests that are made for other reasons (e.g., one or more reasons that would not obligate the company to respond to the request). These reasons may include, for example, malicious or other reasons such as: (1) research by an academic institution by one or more students or professors; (2) anticompetitive requests by one or more competitors; (3) requests by disgruntled former employees for nefarious reasons; (4) etc.

In particular embodiments, the system may, for example, maintain a database (e.g., in computer memory) of former employees. In other embodiments, the system may, for example: (1) identify a plurality of IP addresses associated with a particular entity (e.g., academic organization, competitor, etc.); and (2) substantially automatically reject a data subject access request that originates from the plurality of IP addresses. In such embodiments, the system may be configured to automatically add such identified IP addresses and/or domains to the blacklist.

In still other embodiments, the system is configured to maintain a listing of blacklisted names of particular individuals. These may include, for example, one or more individuals identified (e.g., by an organization or other entity) as submitting malicious data subject access requests).

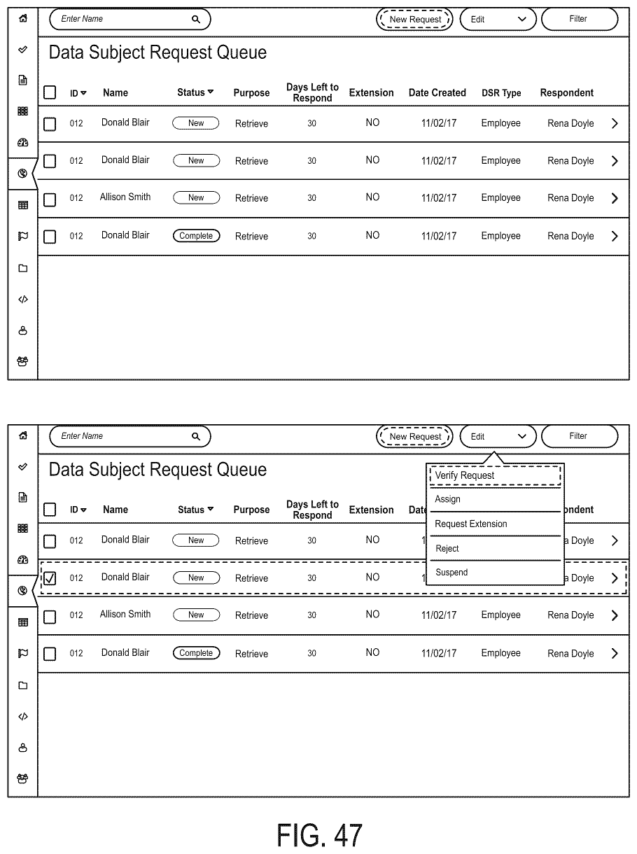

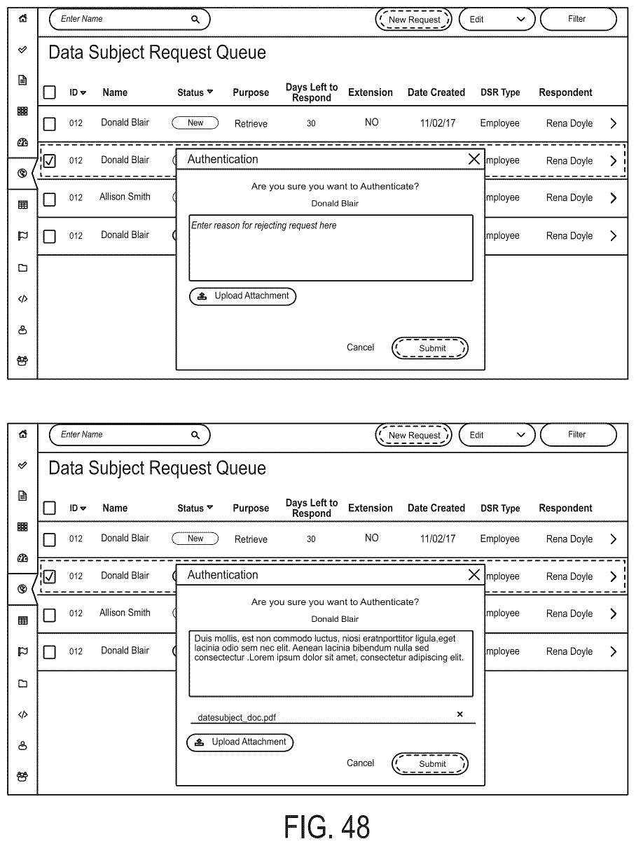

FIG. 47 depicts a queue of pending data subject access requests. As shown in this figure, the first three listed data subject access requests are new and require verification before processing and fulfillment can begin. As shown in this figure, a user (e.g., such as a privacy officer or other privacy controller) may select a particular request, and select an indicia for verifying the request. The user may also optionally select to reject the request. FIG. 48 depicts an authentication window that enables the user to authenticate a particular request. In various embodiments, the user may provide an explanation of why the user is authenticating the request (e.g., because the requestor successfully completed on or more out-of-wallet questions or for any other suitable reason). The user may further submit one or more attachments to support the verification. In this way, the system may be configured to document that the authentication process was performed for each request (e.g., in case there was an issue with improperly fulfilling a request, the company could show that they are following procedures to prevent such improper processing). In other embodiments, the system may enable the user to provide similar support when rejecting a request (e.g., because the requestor was blacklisted, made excessive requests, etc.).

### Data Subject Access Request Fulfillment Cost Determination

In various embodiments, as may be understood in light of this disclosure, fulfilling a data subject access request may be particularly costly. In some embodiments, a company may store data regarding a particular data subject in multiple different locations for a plurality of different reasons as part of a plurality of different processing and other business activities. For example, a particular data subject may be both a customer and an employee of a particular company or organization. Accordingly, in some embodiments, fulfilling a data subject access request for a particular data subject may involve a plurality of different information technology (IT) professionals in a plurality of different departments of a particular company or organization. As such, it may be useful to determine a cost of a particular data subject access request (e.g., particularly because, in some cases, a data subject is entitled to a response to their data subject access request as a matter of right at no charge).

In particular embodiments, in response to receiving a data subject access request, the system may be configured to: (1) assign the request to at least one privacy team member; (2) identify one or more IT teams required to fulfill the request (e.g., one or more IT teams associated with one or more business units that may store personal data related to the request); (3) delegate one or more subtasks of the request to each of the one or more IT teams; (4) receive one or more time logs from each individual involved in the processing and fulfillment of the data subject access request; (5) calculate an effective rate of each individual's time (e.g., based at least in part on the individual's salary, bonus, benefits, chair cost, etc.); (6) calculate an effective cost of fulfilling the data subject access request based at least in part on the one or more time logs and effective rate of each of the individual's time; and (7) apply an adjustment to the calculated effective cost that accounts for one or more external factors (e.g., overhead, etc.) in order to calculate a cost of fulfilling the data subject access request.

In particular embodiments, the system is configured to substantially automatically track an amount of time spent by each individual involved in the processing and fulfillment of the data subject access request. The system may, for example, automatically track an amount of time between each individual opening and closing a ticket assigned to them as part of their role in processing or fulfilling the data subject access request. In other embodiments, the system may determine the time spent based on an amount of time provided by each respective individual (e.g., the individual may track their own time and submit it to the system).

In various embodiments, the system is configured to measure a cost of each particular data subject access request received, and analyze one or more trends in costs of, for example: (1) data subject access requests over time; (2) related data subject access requests; (3) etc. For example, the system may be configured to track and analyze cost and time-to-process trends for one or more social groups, one or more political groups, one or more class action groups, etc. In particular, the system may be configured to identify a particular group from which the system receives particularly costly data subject access request (e.g., former and/or current employees, members of a particular social group, members of a particular political group, etc.).

In particular embodiments, the system may be configured to utilize data subject access request cost data when processing, assigning, and/or fulfilling future data subject access requests (e.g., from a particular identified group, individual, etc.). For example, the system may be configured to prioritize requests that are expected to be less costly and time-consuming (e.g., based on past cost data) over requests identified as being likely more expensive. Alternatively, the system may prioritize more costly and time-consuming requests over less costly ones in the interest of ensuring that the system is able to respond to each request in a reasonable amount of time (e.g., within a time required by law, such as a thirty day period, or any other suitable time period).

Customer Satisfaction Integration with Data Subject Access Requests

In various embodiments, the system may be configured to collect customer satisfaction data, for example: (1) as part of a data subject access request submission form; (2) when providing one or more results of a data subject access request to the data subject; or (3) at any other suitable time. In various embodiments, the customer satisfaction data may be collected in the form of a suitable survey, free-form response questionnaire, or other suitable satisfaction data collection format (e.g., thumbs up vs. thumbs down, etc.).

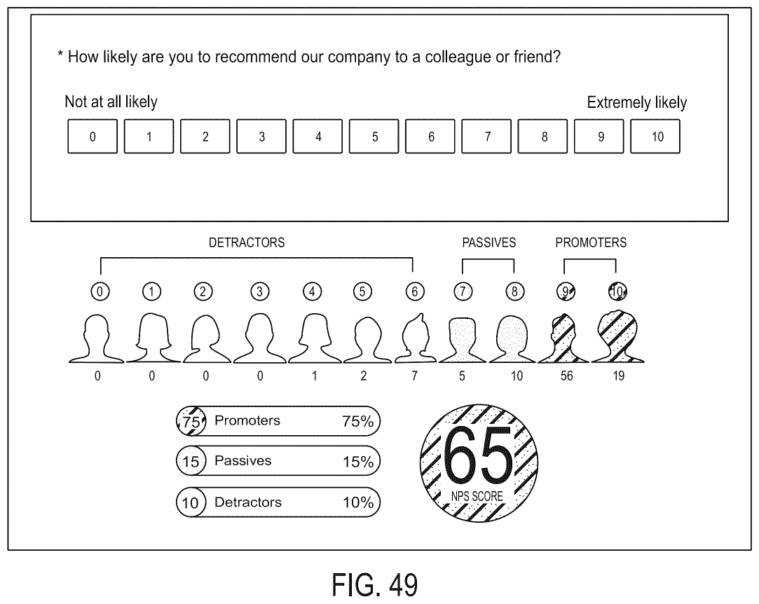

FIG. 49 depicts an exemplary customer satisfaction survey that may be included as part of a data subject access request form, provided along with the results of a data subject access request, provided in one or more messages confirming receipt of a data subject access request, etc. As shown in the figure, the customer satisfaction survey may relate to how likely a customer (e.g., a data subject) is to recommend the company (e.g., to which the data subject has submitted the request) to a friend (e.g., or colleague). In the example shown in FIG. 49, the satisfaction survey may relate to a Net Promoter score (NPS), which may indicate a loyalty of a company's customer relationships. Generally speaking, the Net Promoter Score may measure a loyalty that exists between a provider and a consumer. In various embodiments, the provider may include a company, employer, or any other entity. In particular embodiments, the consumer may include a customer, employee, or other respondent to an NPS survey.

In particular embodiments, the question depicted in FIG. 49 is the primary question utilized in calculating a Net Promoter Score (e.g., “how likely is it that you would recommend our company/product/service to a friend or colleague?”). In particular embodiments, the question is presented with responses ranging from 0 (not at all likely) to 10 (extremely likely). In particular embodiments, the question may include any other suitable scale. As may be understood from FIG. 49, the system may be configured to assign particular categories to particular ratings on the 10 point scale. The system may be configured to track and store responses provided by consumers and calculate an overall NPS score for the provider. The system may be further configured to generate a visual representation of the NPS score, including a total number of responses received for each particular score and category as shown in FIG. 49.

In various embodiments, the system may be configured to measure data related to any other suitable customer satisfaction method (e.g., in addition to NPS). By integrating a customer satisfaction survey with the data subject access request process, the system may increase a number of consumers that provide one or more responses to the customer satisfaction survey. In particular embodiments, the system is configured to require the requestor to respond to the customer satisfaction survey prior to submitting the data subject access request.

### CONCLUSION

Although embodiments above are described in reference to various data subject access fulfillment systems, it should be understood that various aspects of the system described above may be applicable to other privacy-related systems, or to other types of systems, in general.

While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. In addition, it should be understood that terms such as “in some embodiments”, “in various embodiments”, and “in certain embodiments” are intended to indicate that the stated features may be implemented in any suitable embodiment described herein.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A method comprising:
receiving, by computing hardware, a personal data request to perform an action with regard to personal data associated with a data subject, the personal data request originating from a computing device;
detecting, by the computing hardware, a location of the computing device;
determining, by the computing hardware and based on the location of the computing device a required first type of identity verification that requires user-provided input;
transmitting, by the computing hardware, an instruction to the computing device to dynamically display a prompt for the user-provided input to verify an identity of the data subject in connection with the personal data request originating from the computing device;
receiving, by the computing hardware, the user-provided input via the prompt;
verifying, by the computing hardware, the identity of the data subject based on the user-provided input by:
providing first information included in the personal data request to an external system;
receiving second information from the external system based on the first information; and
verifying the identity of the data subject based on the user-provided input and the second information; and
responsive to verifying the identity of the data subject in connection with the personal data request originating from the computing device, causing, by the computing hardware, performance of the action with regard to the personal data associated with the data subject.

2. The method of claim 1, wherein the action comprises at least one of retrieving and displaying the personal data on the computing device, deleting the personal data from at least one data repository, or updating the personal data in the at least one data repository.

3. The method of claim 1, further comprising:
determining that the personal data request requires a second type of identity verification that requires second user-provided input; and
dynamically generating a graphical user interface for display on the computing device, wherein the graphical user interface is configured with one or more input elements to prompt a requestor to provide the second user-provided input.

4. The method of claim 1, wherein determining, by the computing hardware and based on the location of the computing device the required first type of identity verification that requires user-provided input comprises identifying, by the computing hardware, a law that applies to the personal data request based on the location.

5. The method of claim 1, further comprising generating, by the computing hardware, a knowledge-based authentication question based on the second information, wherein the prompt comprises the knowledge-based authentication question and the user-provided input comprises an answer to the knowledge-based authentication question.

6. The method of claim 1, wherein the prompt comprises a secure link through which the user-provided input is provided to prevent outside access to the user-provided input.

7. The method of claim 1, wherein dynamically displaying the prompt for the user-provided input comprises providing a custom user interface for the data subject based on the location.

8. A system comprising:
at least one processor; and
at least one memory device coupled to the at least one processor that causes the system to perform operations comprising:
receiving, by computing hardware, a personal data request to perform an action with regard to personal data associated with a data subject, the personal data request originating from a computing device;
detecting a location of the computing device;
determining, by the computing hardware and based on the location of the computing device a first type of identity verification that requires user-provided input;
generating, by the computing hardware and based on required type of identity verification, a graphical user interface by configuring a first identity verification prompt on the graphical user interface and excluding a second identity verification prompt from the graphical user interface, wherein:
the first identity verification prompt is configured for receiving input for the first type of identity verification, and
the second identity verification prompt is configured for receiving input for a second type of identity verification that requires at least one piece of identify information for the data subject;
verifying an identity of the data subject based on the user-provided input provided via the graphical user interface; and
responsive to verifying the identity of the data subject in connection with the personal data request originating from the computing device, causing performance of the action with regard to the personal data associated with the data subject.

9. The system of claim 8, wherein the action comprises at least one of retrieving and displaying the personal data on the computing device, deleting the personal data from at least one data repository, or updating the personal data in the at least one data repository.

10. The system of claim 8, wherein the location of the computing device comprises at least one of a current geographical location of the computing device or a past geographical location of the computing device.

11. The system of claim 8, wherein verifying the identity of the data subject based on the user-provided input comprises:
providing first information included in the personal data request to an external system;
receiving second information from the external system based on the first information; and
verifying the identity of the data subject based on the user-provided input.

12. The system of claim 11, wherein the operations further comprising generating a knowledge-based authentication question based on the second information, and the first identity verification prompt comprises the knowledge-based authentication question and the user-provided input comprises an answer to the knowledge-based authentication question.

13. The system of claim 8, wherein determining, by the computing hardware and based on the location of the computing device the required type of identity verification that requires user-provided input comprises identifying, by the computing hardware, a law that applies to the personal data request based on the location.

14. A non-transitory computer-readable medium having program code that is stored thereon, the program code executable by one or more processing devices for performing operations comprising:
receiving, by computing hardware, a personal data request to perform an action with regard to personal data associated with a data subject, the personal data request originating from a computing device;
detecting, by the computing hardware, a location of the computing device;
determining, by the computing hardware and based on the location of the computing device a required type of identity verification that requires user-provided input;
transmitting, by the computing hardware, an instruction to the computing device to dynamically display a prompt for the user-provided input to verify an identity of the data subject in connection with the personal data request originating from the computing device;
receiving, by the computing hardware, the user-provided input via the prompt;
verifying, by the computing hardware, the identity of the data subject based on the user-provided input by:
providing first information included in the personal data request to an external system;
receiving second information from the external system based on the first information; and
verifying the identity of the data subject based on the user-provided input and the second information; and
responsive to verifying the identity of the data subject in connection with the personal data request originating from the computing device, causing, by the computing hardware, performance of the action with regard to the personal data associated with the data subject.

15. The non-transitory computer-readable medium of claim 14, wherein determining, by the computing hardware and based on the location of the computing device the required type of identity verification that requires user-provided input comprises identifying, by the computing hardware, a law that applies to the personal data request based on the location.

16. The non-transitory computer-readable medium of claim 14, wherein the action comprises at least one of retrieving and displaying the personal data on the computing device, deleting the personal data from at least one data repository, or updating the personal data in the at least one data repository.

17. The non-transitory computer-readable medium of claim 14, wherein the location of the computing device comprises at least one of a current geographical location of the computing device or a past geographical location of the computing device.

18. The non-transitory computer-readable medium of claim 14, wherein providing the personal data request to the external system comprises sending a search request comprising the personal data request to the external system, wherein the search request is for the external system to confirm that the data subject of the personal data request exists.

19. The non-transitory computer-readable medium of claim 18, wherein the operations further comprise generating a knowledge-based authentication question based on the second information, the prompt comprises the knowledge-based authentication question and the user-provided input comprises an answer to the knowledge-based authentication question.

20. The non-transitory computer-readable medium of claim 14, wherein the prompt comprises a secure link through which the user-provided input is provided to precent outside access to the user-provided input.
